(19) United States
(12) Patent Application Publication
(10) Pub. No.: US 2014/0032973 A1
(43) Pub. Date: Jan. 30, 2014

(54) SYSTEM AND METHOD FOR ROBUST PATTERN ANALYSIS WITH DETECTION AND CORRECTION OF ERRORS

(71) Applicant: JAMES K. BAKER REVOCABLE TRUST, Maitland, FL (US)

(72) Inventor: James K. BAKER, Maitland, FL (US)

(73) Assignee: James K. Baker Revocable Trust, Maitland, FL (US)

(21) Appl. No.: 13/799,105

(22) Filed: Mar. 13, 2013

Related U.S. Application Data
(60) Provisional application No. 61/681,420, filed on Aug. 9, 2012.
(60) Provisional application No. 61/675,989, filed on Jul. 26, 2012.

(51) Int. Cl. G06F 11/30; G06N 5/04

(52) U.S. Cl. CPC G06F 11/3072; G06N 5/047
USPC 714/39; 706/48

(57) ABSTRACT

A pattern analysis system and method that is robust against errors, misalignments and failures of process that may be caused by unexpected events. By performing multiple, redundant overlapping analyses with different operating characteristics and by actively testing for disagreements and errors, the invention detects errors and either corrects them or at least eliminates their harmful effects. The invention is especially effective in highly constrained situations, such as training a model to a script that is presumed correct or recognition with a highly constrained grammar or language model. In particular, it is effective when unexpected events may be rare but disastrous when they occur. The system and method handle errors that would otherwise be undetected as well as errors that would cause catastrophic failures.

### CROSS-REFERENCE TO RELATED PATENT APPLICATIONS

This application claims priority from Provisional U.S. Application 61/681,420, filed Aug. 9, 2012 and Provisional U.S. Application 61/675,989 filed Jul. 26, 2012. All of the aforesaid applications are incorporated herein by reference in their entirety as if fully set forth herein.

### SUMMARY

In embodiments, a system of pattern analysis is disclosed comprising: one or more computers, configured with program code to perform, when executed, the steps: obtaining or receiving, by the one or more computers, a sequence of features; obtaining or receiving, by the one or more computers, a plurality of pattern models; performing, by the one or more computers, a plurality of searches for instances of one or more pattern models in a specified subset of said plurality of pattern models to determine one or more estimated locations of instances of the one or more pattern models within said sequence of features by matching the one or more particular models in said plurality of pattern models; performing, by the one or more computers, one or more tests to detect errors in said estimated locations of instances matching the one or more particular models and obtaining test results; wherein each of said plurality of searches is performed within a specified subrange of said sequence of features; and wherein for each of said plurality of searches, the specified subset of pattern models to be matched, and the specified subrange of the sequence of features to be search, is based at least in part on the estimated locations of the instances of previous searches and is based at least in part on the test results of said one or more tests to detect errors in said estimated locations of matches in said previous searches.

In embodiments, the system of pattern analysis may be configured to operate with said sequence of features associated with a sequence of points in time.

In embodiments, the one or more computers are further configured with program code to perform, when executed, the steps: obtaining or receiving, by the one or more computers, a script-like network model for the sequence of features, and obtaining or receiving, by the one or more computers, one or more of said pattern models based at least in part on a subnetwork of said script-like network.

In embodiments, the system of pattern analysis may be configured so that one or more of said tests to detect errors in said estimated locations comprise one or more anchored matches of one or more subnetworks of said script-like network that are adjacent in said script-like network to a previously matched subnetwork.

In embodiments, the system of pattern analysis may be configured to produce estimated locations aligning a sequence of pattern models to substantially all of said sequence of features.

In embodiments, of the system of pattern analysis said plurality of searches are configured to produce estimated locations aligning portions of said script-like network to portions of said sequence of features and the system further comprises the one or more computers configured with program code to perform, when executed, the step of determining that one or more remaining portions of said sequence of features do not match well with the corresponding portions of said script-like network.

In embodiments, the system of pattern analysis further comprises the one or more computers configured with program code to perform, when executed, the step of obtaining or receiving a preliminary association of each of a plurality of special locations in the sequence of features with one or more locations in the script-like network model.

In embodiments, the system of pattern analysis may be configured to operate to identify or to receive tentative identification of one or more of said plurality of special locations in the sequence of features as a possible inter-sentence pause.

In embodiments, the system of pattern analysis may further comprise the one or more computers configured with program code to perform, when executed, the steps: testing, by the one or more computers, the preliminary association of one or more of the special locations with a particular point in the script-like network; and performing, by the one or more computers, forward and backward matches of adjacent portions of the script-like network against adjacent portions of the sequence of features.

In embodiments, the system of pattern analysis may further comprise the one or more computers configured with program code to perform, when executed, the steps: obtaining or receiving, by the one or more computers, a set of externally specified estimated locations corresponding to a plurality of points in the script-like network model; testing, by the one or more computers, one or more of the externally specified estimated locations; and correcting, by the one or more computers, errors detected in the externally specified estimated locations.

In embodiments, the system of pattern analysis may further be configured to operate where said sequence of features is a sequence of acoustic features associated with a time sequence of speech data.

In embodiments, the system of pattern analysis may further comprise the one or more computers configured with program code to perform, when executed, the steps: obtaining or receiving, by the one or more computers, a language model based at least in part on one of a grammar or a statistical language model for sequences of word-like entities that sequences of such word-like entities are likely to match subsequences of said sequence of features; and obtaining or receiving, by the one or more computers, one or more of said pattern models based at least in part on sequences of one or more of said word-like entities.

In embodiments, the system of pattern analysis may further be configured to operate with said plurality of searches configured to produce matches corresponding to recognition of one or more portions of said sequence of features as sequences of said word-like entities.

In embodiments, the system of pattern analysis may further be configured to operate with each of said word-like entities is a sequence of sound units.

In embodiments, the system of pattern analysis may further be configured to operate with one or more of said sequences of sound units is one of a demi-syllable, a syllable, a sequence of syllables, a word or a sequence of words.

In embodiments, the system of pattern analysis may further be configured to operate with one or more of said searches being an unanchored search.

In embodiments, the system of pattern analysis may further be configured to operate with one or more of said searches being an anchored match.

In embodiments, the system of pattern analysis may further be configured to operate with one or more of said searches being an unanchored search and one or more searches being an anchored match.

In embodiments, the system of pattern analysis may further be configured to operate with one or more of the searches configured to be performed by a match computation proceeding forward in the sequence of features and one or more of the searches configured to be performed by a match computation proceeding backward in the sequence of features.

In embodiments, the system of pattern analysis further comprises the one or more computers configured with program code to perform, when executed, the step of beam pruning of the one or more backward match computations independently of any beam pruning of any of the forward match computations.

In embodiments, the system of pattern analysis further comprises the one or more computers configured with program code to perform, when executed, the step of detecting discrepancies between the forward match computation and the backward match computation, wherein one or more of the tests to detect errors in the estimated locations is based at least in part on the discrepancies between the forward match computation and the backward match computation.

In embodiments, the system of pattern analysis further comprises the one or more computers configured with program code to perform, when executed, the steps: performing, by the one or more computers, a plurality of searches in overlapping specified subranges of the sequence of features; and detecting, by the one or more computers, inconsistencies among the plurality of the searches performed in the overlapping specified subranges, wherein one or more of the tests to detect errors in the estimated locations is based at least in part on the inconsistencies among the plurality of the searches performed in the overlapping specified subranges.

In embodiments, the system of pattern analysis further comprises the one or more computers configured with program code to perform, when executed, the step of eliminating one or more of the errors detected in said estimated locations of matches.

In embodiments, the system of pattern analysis further comprises the one or more computers configured with program code to perform, when executed, the step of correcting one or more of the errors detected in said estimated locations of matches.

In embodiments, the system of pattern further comprises correcting, by the one or more computers, the error in one or more estimated locations by replacing a location estimate by a new location estimate that is based at least in part on the combined information from a forward alignment computation and a backward alignment computation.

In embodiments, a system of pattern analysis is disclosed comprising: one or more computers, configured with program code to perform, when executed, the steps: obtaining or receiving, by the one or more computers, a sequence of features; obtaining or receiving, by the one or more computers, a primary model for a particular pattern; obtaining or receiving, by the one or more computers, an estimated beginning time or an estimated ending time for an instance of the particular pattern in the sequence of features; performing, by the one or more computers, a unidirectional first match computation based at least in part on the primary model for an instance of the particular pattern matched against the sequence of features beginning at the estimated beginning time or ending at the estimated ending time to obtain a set of active states and a match score for each of the active states; pruning, by the one or more computers, the set of active states in the first match computation as a function of the time in the sequence of features such that not all states in the primary model are active for each time point in the sequence of features; performing, by the one or more computers, a second, reversed, match computation for an instance of the particular pattern matched against the sequence of features with the match computation proceeding in the opposite time direction from the first match computation to obtain a set of active states and a match score for each of the active states; pruning, by the one or more computers, the set of active states in the second match computation based at least in part on the match scores from the opposite time direction in a manner such that states that were pruned and made inactive at a particular time point in the first match computation may be active in the second match computation; and detecting, by the one or more computers, discrepancies between the first match computation and the second match computation based at least in part on disagreements in pruning decisions of the second match computation and the first match computation.

In embodiments, the system of pattern analysis further comprises the one or more computers configured with program code to perform, when executed, the step of performing the pruning of the set of active states in the first match computation based at least in part on the match scores of each of the active states at a given time point in the sequence of features.

In embodiments, the system of pattern analysis further comprises the one or more computers configured with program code to perform, when executed, the step of detecting when one or more of the active states in the second match computation would have been pruned and made inactive in the first match computation.

In embodiments, the system of pattern analysis further comprises the one or more computers configured with program code to perform, when executed, the steps: performing, by the one or more computers, a revised match computation in the same time direction as the first match computation based at least in part on keeping active and not pruning one or more states that are active in the second match computation but not active in the first match computation; computing, by the one or more computers, an optimum state sequence for matching the particular pattern against the sequence of features based at least in part on the revised match computation and the second match computation; and detecting, by the one or more computers, when a state in the optimum state sequence would have been pruned and made inactive in the first match computation at a time that it would be active in the optimum state sequence.

In embodiments, a system of pattern analysis is disclosed comprising: one or more computers, configured with program code to perform, when executed, the steps: obtaining or receiving, by the one or more computers, a particular sequence of features; obtaining or receiving, by the one or more computers, a particular model for a particular pattern; obtaining or receiving, by the one or more computers, a background model collectively representing all other patterns; obtaining or receiving, by the one or more computers, a specification of a subsequence of the sequence of features; obtaining or receiving, by the one or more computers, a specification of the number of times that instances of the particular pattern occur in the specified subsequence; and performing, by the one or more computers, a numerically constrained unanchored search in the specified subsequence to obtain best estimated locations for a set of the instances of the particular pattern where the number of instances exactly matches the specification of the number of times that the particular pattern occurs in the specified subsequence.

In embodiments, the system of pattern analysis may further be configured to operate with the specified number of times that the particular pattern occurs in the specified subsequence being exactly one.

In embodiments, the system of pattern analysis further comprises the one or more computers configured with program code to perform, when executed, the steps: obtaining, by the one or more computers, a partial script-like network model for a specified subsequence of the sequence of features; selecting, by the one or more computers, as the particular pattern particular pattern model based at least in part on a particular subnetwork of said partial script-like network model; specifying, by the one or more computers, the number of times that the particular pattern occurs in the specified subsequence based at least in part on a number of times that the particular subnetwork, or similar subnetworks, occurs within the partial script-like network model; and performing, by the one or more computers, the unanchored search for instances of the particular pattern based at least in part on the specification.

In embodiments, the system of pattern analysis may further be configured to operate with the partial script-like network and the specified subsequence of the sequence of features based at least in part on estimated locations in the sequence of features of a pair of points in a script-like network for a larger portion of or all of the sequence of features.

In embodiments, the system of pattern analysis further comprising the one or more computers configured with program code to perform, when executed, the step of performing a plurality of the searches in a range to be searched in the specified subsequence by successively dividing the range into smaller subranges and searching that subrange based at least in part on the estimated locations found for particular patterns in previous searches.

In embodiments, the system of pattern analysis may further be configured to operate with the particular sequence of features is in one language, and the one or more computers configured with program code to perform, when executed, the step of obtaining at least in part the particular pattern by translating a word or phrase of a second language for use in the numerically constrained unanchored search.

In embodiments, a method of pattern analysis is disclosed comprising: obtaining or receiving, by one or more computers, a sequence of features; obtaining or receiving, by the one or more computers, a plurality of pattern models; performing, by the one or more computers, a plurality of searches for instances of one or more pattern models in a specified subset of said plurality of pattern models to determine one or more estimated locations of instances of the one or more pattern models within said sequence of features by matching the one or more particular models in said plurality of pattern models; performing, by the one or more computers, one or more tests to detect errors in said estimated locations of instances matching the one or more particular models and obtaining test results; wherein each of said plurality of searches is performed within a specified subrange of said sequence of features; and wherein for each of said plurality of searches, the specified subset of pattern models to be matched, and the specified subrange of the sequence of features to be search, is based at least in part on the estimated locations of the instances of previous searches and is based at least in part on the test results of said one or more tests to detect errors in said estimated locations of matches in said previous searches.

In embodiments, a program product for pattern analysis is disclosed comprising: a non-transitory computer-readable medium configured with program code, that when executed, causes one or more computers to perform the steps: obtaining or receiving, by the one or more computers, a sequence of features; obtaining or receiving, by the one or more computers, a plurality of pattern models; performing, by the one or more computers, a plurality of searches for instances of one or more pattern models in a specified subset of said plurality of pattern models to determine one or more estimated locations of instances of the one or more pattern models within said sequence of features by matching the one or more particular models in said plurality of pattern models; performing, by the one or more computers, one or more tests to detect errors in said estimated locations of instances matching the one or more particular models and obtaining test results; wherein each of said plurality of searches is performed within a specified subrange of said sequence of features; and wherein for each of said plurality of searches, the specified subset of pattern models to be matched, and the specified subrange of the sequence of features to be search, is based at least in part on the estimated locations of the instances of previous searches and is based at least in part on the test results of said one or more tests to detect errors in said estimated locations of matches in said previous searches.

In embodiments, a method of pattern analysis is disclosed comprising: obtaining or receiving, by one or more computers, a sequence of features; obtaining or receiving, by the one or more computers, a primary model for a particular pattern; obtaining or receiving, by the one or more computers, an estimated beginning time or an estimated ending time for an instance of the particular pattern in the sequence of features; performing, by the one or more computers, a unidirectional first match computation based at least in part on the primary model for an instance of the particular pattern matched against the sequence of features beginning at the estimated beginning time or ending at the estimated ending time to obtain a set of active states and a match score for each of the active states; pruning, by the one or more computers, the set of active states in the first match computation as a function of the time in the sequence of features such that not all states in the primary model are active for each time point in the sequence of features; performing, by the one or more computers, a second, reversed, match computation for an instance of the particular pattern matched against the sequence of features with the match computation proceeding in the opposite time direction from the first match computation to obtain a set of active states and a match score for each of the active states; pruning, by the one or more computers, the set of active states in the second match computation based at least in part on the match scores from the opposite time direction in a manner such that states that were pruned and made inactive at a particular time point in the first match computation may be active in the second match computation; and detecting, by the one or more computers, discrepancies between the first match computation and the second match computation based at least in part on disagreements in pruning decisions of the second match computation and the first match computation.

In embodiments, a program product for pattern analysis is disclosed comprising: a non-transitory computer-readable medium configured with program code, that when executed, causes one or more computers to perform the steps: obtaining or receiving, by the one or more computers, a sequence of features; obtaining or receiving, by the one or more computers, a primary model for a particular pattern; obtaining or receiving, by the one or more computers, an estimated beginning time or an estimated ending time for an instance of the particular pattern in the sequence of features; performing, by the one or more computers, a unidirectional first match computation based at least in part on the primary model for an instance of the particular pattern matched against the sequence of features beginning at the estimated beginning time or ending at the estimated ending time to obtain a set of active states and a match score for each of the active states; pruning, by the one or more computers, the set of active states in the first match computation as a function of the time in the sequence of features such that not all states in the primary model are active for each time point in the sequence of features; performing, by the one or more computers, a second, reversed, match computation for an instance of the particular pattern matched against the sequence of features with the match computation proceeding in the opposite time direction from the first match computation to obtain a set of active states and a match score for each of the active states; pruning, by the one or more computers, the set of active states in the second match computation based at least in part on the match scores from the opposite time direction in a manner such that states that were pruned and made inactive at a particular time point in the first match computation may be active in the second match computation; and detecting, by the one or more computers, discrepancies between the first match computation and the second match computation based at least in part on disagreements in pruning decisions of the second match computation and the first match computation.

In embodiments, a method of pattern analysis is disclosed comprising: obtaining or receiving, by one or more computers, a particular sequence of features; obtaining or receiving, by the one or more computers, a particular model for a particular pattern; obtaining or receiving, by the one or more computers, a background model collectively representing all other patterns; obtaining or receiving, by the one or more computers, a specification of a subsequence of the sequence of features; obtaining or receiving, by the one or more computers, a specification of the number of times that instances of the particular pattern occur in the specified subsequence; and performing, by the one or more computers, a numerically constrained unanchored search in the specified subsequence to obtain best estimated locations for a set of the instances of the particular pattern where the number of instances exactly matches the specification of the number of times that the particular pattern occurs in the specified subsequence.

In embodiments, a program product for pattern analysis is disclosed comprising: a non-transitory computer-readable medium configured with program code, that when executed, causes one or more computers to perform the steps: obtaining or receiving, by one or more computers, a particular sequence of features; obtaining or receiving, by the one or more computers, a particular model for a particular pattern; obtaining or receiving, by the one or more computers, a background model collectively representing all other patterns; obtaining or receiving, by the one or more computers, a specification of a subsequence of the sequence of features; obtaining or receiving, by the one or more computers, a specification of the number of times that instances of the particular pattern occur in the specified subsequence; and performing, by the one or more computers, a numerically constrained unanchored search in the specified subsequence to obtain best estimated locations for a set of the instances of the particular pattern where the number of instances exactly matches the specification of the number of times that the particular pattern occurs in the specified subsequence.

### BRIEF DESCRIPTION OF DRAWINGS

FIG. 1 is a flowchart of the overall process for robustly computing an alignment between a nominal script or constrained recognition network and a sequence of data features that may include unexpected events.

FIG. 2 is a flowchart of an embodiment of the selection and performance of an anchored or unanchored search.

FIG. 3 is a flowchart an embodiment of a match computation.

FIG. 4 is a flowchart of robust error detection based on multiple methods.

FIG. 5 is a flowchart of one embodiment of error correction.

FIG. 6 is a flowchart of an embodiment of the invention based on sentence alignment followed by detailed alignment.

FIG. 7 is a flowchart of one embodiment of sentence-by-sentence alignment.

FIG. 8 is a flowchart of one embodiment of a process for estimating the location of a sentence boundary.

FIG. 9 is a diagram of a grammar designed to detect multiple instances of a specified target pattern.

FIG. 10 is a diagram of a grammar designed to detect exactly one instance of a specified target pattern.

FIG. 11 is a sketch of a portion of a grammar network that allows optional inter-word pauses.

FIG. 12 is a sketch of a portion of a grammar network that allows arbitrary sequences of other speech sounds to be interposed among detected instances of elements of a specified target grammar network.

FIG. 13 is a sketch of a portion of a grammar network that allows one and only one interjection of a sequence of other speech sounds between elements of a specified target grammar network.

FIG. 14 is a sketch of a portion of a grammar network that allows a single interjection of a sequence of other speech sounds and that also allows elements of a target grammar network to be skipped or repeated.

FIG. 15 is a sketch of a portion of a grammar network that models a reader making an error of skipping or repeating a work in a target sequence.

FIG. 16 is a sketch of a portion of a phoneme pronunciation network that allows an alternate pronunciation.

FIG. 17 is a sketch of a portion of a network that allows multiple elements to be skipped.

FIG. 18 is a diagram of the beam of active states in an embodiment of forward and backward match computations and their relationship in time and state position within the script.

FIG. 19 is a diagram of the active beams of forward and backward match computations where the active beams overlap in time and state position.

FIG. 20 is a diagram of the active beams of forward and backward match computations where, at a corresponding time, the active states for the backward computation are later in script state position than the active states for the forward computation.

FIG. 21 is a diagram of the active beams of forward and backward match computations where, for the same script state position, the backward computation active times are later in time than the active times for the forward computation.

FIG. 22 is a diagram of the active beams of forward and backward match computations where, at a corresponding time, the active states for the backward computation are later in script state position than the active states for the forward computation, as in FIG. 20, with the indication that the gap may be filled using a grammar that allows skips.

FIG. 23 is a diagram corresponding to one embodiment in which a gap in both time and script state position may be filled by modeling the speaker substituting one or more other words for words in the specified script.

FIG. 24 is a diagram of one embodiment in which a gap in both time and script state position may be filled in by additional anchored or unanchored searches.

FIG. 25 is a schematic block diagram of a computer configuration to implement embodiments of the invention.

### DETAILED DESCRIPTION OF EMBODIMENTS

U.S. Pat. No. 8,014,591, U.S. Pat. No. 8,180,147, U.S. Pat. No. 8,331,657, and U.S. Pat. No. 8,331,656 are hereby incorporated by reference into this specification in their entirety for all purposes as if fully set forth herein. Embodiments of this invention deal with a problem that is present in many model-based pattern recognition systems, namely the lack of robustness of the analysis when encountering events that the model does not expect or that are modeled as very unlikely. In the particular case of speech recognition, this problem has been present, but unresolved, for many years. One form in which this problem manifests itself in speech recognition is that standard acoustic model training routines fail when processing long duration audio files. These same acoustic model training routines work very reliably, even when processing large amount of data, if the acoustic files are first broken up into relatively short files of duration at most a few minutes, if each of the short files has been associated with a particular portion of the script. A primary reason for the failure of the training process for long audio files is that for long files, there is a non-negligible probability that at least one unexpected event will occur within the file. Historically, research systems were originally developed on the slower, lower capacity computers that were available at the time, using smaller amounts of data. As computers became more powerful and more data became available, the lack of robustness of the acoustic model training for long audio files was noticed. However, rather than being solved by a change in methodology, the problem was avoided by breaking up long files into shorter segments, even if that required manual labor to associate each short file with the proper segment of the script. For research corpora that were used by multiple groups for many experiments this process of breaking up the long files only had to be done once, so the cost was not prohibitive even if the process had to be done manually. However, this manual process is no longer practical with the enormous quantities of data that are now becoming available.

The problems addressed by embodiments of this invention can occur in any model-based pattern recognition system. The methodology of this invention can be used for any form of pattern recognition or model training in which instances of particular models are sought within a stream or sequence of observed features. The methods are not specific to speech recognition. However, for clarity it is useful to have specific examples of problems and specific embodiments of this invention which provide solutions to these problems. These illustrative examples will be taken from the field of speech recognition, but should not be interpreted as limiting the scope of the invention.

### DISCUSSION OF THE PROBLEM

Most speech systems and other pattern recognition and training systems are very poor at handling unexpected events that occur either during recognition or during the training process. Furthermore, speech acoustic model training may be even less robust with respect to unexpected events than is speech recognition. Also, during recognition with highly constrained grammars or low perplexity statistical language models, designed to lower the average error rate, may make the system more fragile with respect to unexpected events. In these more highly constrained situations, there is less of the flexibility that might be needed to get back on track after an unexpected event.

With some applications of less constrained recognition, the pattern recognition may be able to proceed with the recognition process after it has made an error because of some an unexpected event. After an error, recognition of the continuing sequence of observed features can often progress in spite of the error. Speech acoustic model training, however, sometimes has a catastrophic failure when it encounters an unexpected event. Acoustic model training generally tries to align an audio data stream with a specified script. Typically, the aligning process proceeds start-to-end through the audio data, with the alignment of each section starting from the alignment already computed on the preceding section. Unfortunately, unexpected events can cause this process to fail and not to be able to recover. In addition, when an unexpected event does not cause a catastrophic failure, it will often cause an alignment error that goes undetected. Furthermore, this phenomenon of catastrophic failure occurs not only for alignment in training, but may also occur in recognition with a grammar or language model with low perplexity or high relative redundancy.

An essential process in some embodiments of the invention is to match an observed sequence of data features to a model for the probability distribution of such sequences. A sequence of feature is simply a set of feature measurements that are arranged in sequence. That is, they are numbered, with each feature measurement associated with an integer in an interval of integers. A feature measurement may be a complex measurement: for example a feature may be a vector of simple measurements. In some embodiments the associated integers are units of time.

By way of example, a sequence of data features for an audio recording may be a sequence of data frames resulting from periodically performing a frequency analysis of a short interval of audio. For speech analysis, such a frequency analysis might be done every 10 msec and the analysis may cover a short interval or frame of 25 msec, so successive analysis intervals will overlap. The frequency analysis of each short audio interval will result in a vector of measurements, such as the amplitude at each of a range of frequencies. Although each such measurement could be regarded as a separate feature measurement, for purposes of this discussion, the entire vector of measurements for a given audio interval will be treated as a unit and be regarded as a (vector-valued) feature in the sequence of features that results from performing such frequency analysis on successive intervals of time.

Embodiments of the invention use methods that are robust against unexpected events in the sense that the methods detect and eliminate alignment errors. These procedures can be used in either recognition or training, but they are especially useful for training and for recognition in low perplexity situations. Without the robustness of this invention, the low perplexity reduces a pattern recognition system's ability to expect the unexpected.

For the purposes of this discussion, an unexpected event is any event that has an exceptionally low probability according to the models being used. It may indeed be a very rare event, or it may merely be unexpected because the model is wrong or over confident, or otherwise doesn't expect the event to be as likely as it actually is. Whether a particular event should be thought of as unexpected can be judged by the behavior of the pattern recognition or model training system. In particular, if an alignment system makes an error or has a failure in the vicinity of an event to which is has assigned a very low probability, then the error can be attributed to the fact that the system did not expect that event.

Not surprisingly, there can be many different causes for unexpected events. For speech recognition or acoustic model training systems, here is a list of some of the causes of unexpected events:

1) An exceptional background noise

2) An error in the pronunciation dictionary

3) The speaker using a pronunciation that is not in the dictionary

4) The speaker making a non-speech sound

5) The speaker saying something that doesn't match the script

In some situations, unexpected events are more likely than in others. There are several situations in speech processing in which unexpected events are especially likely to occur:
1) In the initial phases of training in a new environment (new language, new genre, new acoustic environment, new speaker, etc.)
2) For speakers with dialects or foreign accents
3) For speech intermixing multiple languages
4) For casual conversational speech
5) For speech in a high noise environment
6) For speech in an environment of intermittent noise
7) For long audio files, because a single unexpected event anywhere in the file can cause a catastrophic failure

Long audio files are a particularly important case. It is well known that statistical pattern recognition or machine learning can perform much better when there is a large amount of data available to train the models. In the case of speech recognition, there is a large amount of speech data readily available. It is in the form of radio and television broadcasts, audio books, YouTube videos and podcasts. There are millions of hours of such data available. However, unlike many specially recorded speech recognition research corpora, if there is a script available in these cases, it is often associated only with the broadcast as a whole, not broken up into individual sentences. The quantity of material would make it prohibitively expensive to manually align each individual sentence in the script to the right place in the audio file. Therefore, it is desirable to be able to use an automatic alignment procedure that can robustly handle long audio files.

However, even though automatic alignment procedures are available that generally work well when the material has already been broken up into individual sentences, these procedures do not work as well for aligning long audio files or data streams. One problem is that, even when the unexpected events are somewhat rare, they are not so rare that they never occur. The probability of encountering at least one unexpected event increases the longer the audio data stream. The situation is even worse if the reason for using long audio files is to obtain inexpensive data for the initial training in a new environment. The initial models may be a poor match for the data, which creates more unexpected events.

The difficulty of handling the unexpected was clear to the ancient Greeks, including Heraclitus, who said “He who does not expect the unexpected will not find it, for it is trackless and unexplored.” Most speech recognition systems also lack the wisdom of Socrates when he said “The only thing I know is that I don't know anything.” That is, these systems, lacking the wisdom of Socrates, don't even know that that they should try to find the unexpected, much less be expecting it. Therefore, when they encounter an unexpected event either they fail even to detect that they have made an alignment error or they have an undiagnosed catastrophic failure.

Of course, in general it is not possible to know what particular unexpected event to expect. Therefore, the methods and procedures in this invention expect that unexpected events will occur without knowing beforehand what those events will be. In particular, this invention presents robust, redundant procedures for detecting that alignment errors have occurred and for eliminating or correcting those errors when they do occur.

However, sometimes there is at least some knowledge available about what kinds of unexpected events might occur. In a well-known paraphrase of Socrates, “we know [something about] what we don't know.” Embodiments of the invention provide a flexible means to represent knowledge about the form of possible unexpected events. Then events that would otherwise be unexpected are not completely unanticipated.

However, unexpected events will still occur. Alignments errors will still happen. To think that all unexpected events can be anticipated would violate Heraclitus' dictum. Therefore, the only way that we can fully prepare for unexpected events in an alignment computation is to provide mechanisms for detecting errors when they happen. Embodiments of the invention provide multiple means for detecting errors in the alignment. It also provides means for handling these errors in ways that minimize the disruption to the alignment process. It further provides means for correcting many of the errors.

In the typical alignment process in training a speech recognition system, there are three things available:

First, there is the speech to be aligned. This speech may be prerecorded and saved in a data file; it may be a live stream of data presented in real-time or on demand; or it may be pre-processed audio data on which signal processing has already been performed to produce a sequence of frames or vectors of acoustic feature measurements. For the purpose of embodiments of the invention, it does not matter what form the audio data takes. More generally, embodiments of the this invention apply to robust alignment for model training for pattern recognition in which the data can be represented as a sequence of features or as a sequence of vectors of features. It also applies to robust recognition of a sequence of models, especially when the set of likely sequences is highly constrained. The models in such sequences of models are not necessarily actual words in a language, and the terms “grammar” and “language model” are abstractions that refer to the mathematical models that generalize the concepts of words, grammars and languages. In pattern recognition of sequences that are not language in the normal sense, any set of unit models that occur in sequences are mathematically like the “words” in a speech network model. For example, in a DNA molecule, the individual nucleotides correspond to letters or sounds (phonemes) and the genes correspond to words or sentences.

Second, there is a “script” identifying what was spoken or the observed data feature sequence. Typically, this script is a text file representing the speech as a sequence of written words, as if the speech came from reading this text. More generally, this knowledge can be a deterministic or probabilistic grammar or a statistical language model, or even an abstract mathematical model of a hidden stochastic process.

Third, there is a pronunciation dictionary which represents each of the possible pronunciations of each of the written words. Sometimes the explicit dictionary is not complete, in which case it is supplemented by automatically generated pronunciations, such as by a grapheme-to-sound transduction program. Again, for the purposes of embodiments of the invention, the source of the pronunciations does not matter. In fact, embodiments of the invention are designed to be robust enough that, if a pronunciation dictionary is not available, it can just use the spelling of each word as its pronunciation. More generally, with more abstract models, there may be a network representation of one or more word-like models in terms of smaller, sub-word elements. This third type of knowledge is not essential, and is not necessarily present in all embodiments.

Of course, already knowing the script is like having the answer sheet for a test. Any pattern recognition system should be able to get a perfect score in recognition if it has a script. How, then can there be any difficulty in aligning to a known script? How can alignment to a known script be harder than recognition with no script? The answer is that these tasks are done in different situations with different knowledge available and different criteria of success. For example, recognition is normally attempted only after a pattern recognition system has been trained. Obviously, during initial training fully trained models are not yet available. Also, reliance on a script or a highly constrained grammar causes any event not modeled in the script or grammar to be totally unexpected.

In any new environment or any new language, by definition, the training system starts out with no specific knowledge of the particular language or environment. In fact, some training procedures start with what is called a “flat start” (named after the shape of a probability distribution in which everything is equally likely) and essentially have no knowledge at all, except the script. Remarkably, such systems actually work very well in many situations. Other procedures will use as much knowledge as possible obtained from other environments and other languages. However, there will always be differences in the new environment or new language, so inevitably there will be unexpected events.

One of the reasons for sometimes taking the drastic approach of starting from a flat start is that a system with extra knowledge that “doesn't know what it doesn't know” may be overconfident. It thinks it knows something, but it may be wrong. Such a system may do better when it is right, but it may be more fragile when it is wrong. Embodiments of the invention address this issue of overconfidence.

Given the script and the pronunciation dictionary, the typical alignment procedure uses dynamic programming, or a similar method, to find the best alignment between the script and the observed acoustic data stream. Dynamic programming efficiently examines many different alignments (in effect, exponentially many) to find the best one (or to compute a probability distribution among the best ones). In alignment, as in matching procedures in recognition, the dynamic programming typically proceeds frame-by-frame, where a “frame” is a set of acoustic features typically computed every ten milliseconds of the audio. In processing each frame, it knows the score or probability estimate for each state of a hidden Markov process as it was computed for the previous frame. Because of the Markov property, it does not need to know or make use of any other information about the past history of the Markov process (the procedure may keep such information to use in tracing backward at the end, but it doesn't use it in computing the scores or probabilities for the current frame).

The system knows the probability of a transition from any particular state in the previous frame to any particular state in the current frame (the Markov transition probabilities). It also knows the probability from any state of observing the particular acoustic feature values that are observed in the current frame. From this information, the system can compute the probability or score for each state of the hidden Markov process up through the current frame. Then it can perform a similar computation for the next frame, and so on.

The dynamic programming procedure described above reduces the amount of computation from being exponential in the length of the acoustic data stream to being linear. However, a typical audio feature frame rate is 100 frames per second, so there are 360,000 frames per hour of speech. In the Markov state space representing an hour-long script there are also hundreds of thousands of states. Although the amount of computation and memory only grows linearly in the number of frames, it is also grows with the number of states and is proportional to the product of the two. Therefore, the complete computation described above would have to evaluate and remember the probability or score for about 100 billion <state,frame> pairs.

This brute force computation is impractical for long audio streams, and very wasteful even for shorter streams, so even for short streams most practical alignment procedures do not compute the probability or score for every state for every frame. Instead, at each frame only the most promising states are selected for passing their scores on in the next frame. Generally, the most promising states are taken to be the best scoring state and any other states whose scores are sufficiently close to the score of the best state. This process of eliminating the poorly scoring states is called “beam pruning” because the set of selected (or “active”) states progresses like a beam, moving frame-by-frame through the specified script and the corresponding Markov state space.

It is in the beam pruning that errors can occur and where unexpected events can have drastic consequences. If, for any reason, the Markov state that corresponds to the correct alignment at a particular time has a bad score, it may be pruned. Because they have similar scores or probabilities being passed in from their predecessor states, the other states close in the script to the correct state will also have similar scores and be likely to be pruned, either immediately or within a few frames. When the correct state is pruned, that pruning corresponds to making an error in the alignment. When the nearby states are all pruned, the alignment error becomes even more significant. If enough states around the correct state all get pruned, the states that would be the correct matches for future frames may have no active states capable of passing them probabilities from the previous frame. Then, these states fail to become active and the error propagates to a potential catastrophic failure.

Actually, a catastrophic failure is not necessarily the worst result. A significant alignment error that does not become catastrophic will usually go undetected. Then the incorrect alignment will be used in training the acoustic models, which will be degraded by an indeterminate amount. The error, being undetected, will never be corrected.

For purposes of this discussion, an unexpected event is any event that actually occurs but for which the models estimate a much lower probability than for other possibilities in the same situation. Under this definition, not every unexpected event will cause a pruning error, but for every pruning error there must have been at least one unexpected event, or at least an unexpected sequence of events.

It has already been argued that unexpected events are inevitable. The occurrence of unexpected events must be expected. So, the core problem is that the standard frame-by-frame dynamic programming procedure does not adequately handle these unexpected events.

One approach to alignment that doesn't proceed frame-by-frame is to use spoken term detection (see U.S. Pat. No. 7,231,351). Spoken term detection searches for all instances of a given word or canned phrase in a block of audio, typically the whole stream or file. Therefore, an alignment procedure that starts by doing spoken term detection can detect instances of particular words anywhere in the file and the alignment procedure does not need to progress strictly frame-by-frame.

However, the spoken term detection that is the basis for this procedure has much less information available to it than the standard alignment procedure, which knows the script. Spoken term detection as used in U.S. Pat. No. 7,231,351 doesn't have or doesn't use any information about the context of any instance of its target word or phrase. That is how a spoken term detector can attempt to find every instance of the target in the entire audio stream without first recognizing every word.

Although spoken term detection does not have to proceed frame-by-frame, it has great dangers of its own. Because spoken term detectors use less knowledge, they have a much higher raw error rate than continuous speech recognition. This was proven in the early 1990s by experiments on topic identification in which Dragon Systems demonstrated much higher performance using continuous speech recognition than the state-of-the-art performance obtained from spoken term detection. In that experiment, Dragon Systems used continuous speech recognition without a script. The standard alignment computation, with a script, has yet again much more information than such a continuous speech recognizer, so it has much more information than a spoken term detector.

No matter what models are used for the words or phrases there will be similar words or phrases that might occur. Therefore, in spoken term detection, it is essentially impossible to detect every instance of a target without also sometimes falsely detecting as instances of the target other words or phrases that are similar. There is always a trade-off between missed detections and false alarms. In fact, those knowledgeable in the art of spoken term detection report the performance of their systems in terms of this trade-off.

For some applications, one way to reduce false alarms is to use longer phrases, which have redundancy that can be used to successfully reject many potential false alarms. Indeed, U.S. Pat. No. 7,231,351 uses very long phrases. However, a long phrase has a greater danger of having an unexpected event occur during the long phrase, which aggravates the problem of the trade-off between missed detections and false alarms. It may be impossible to tune a system to detect an instance of a phrase that includes an unexpected event without thereby creating an arbitrarily large number of false alarms.

Although using spoken term detection has problems of its own, it still has the useful ability to skip within the audio stream. However, using spoken term detection as the first phase in alignment does not address the core problem of robustness against unexpected events, namely how to detect and correct errors. Indeed, the procedure of U.S. Pat. No. 7,231,351 goes to elaborate lengths to fill-in for missed detections, but it makes no attempt to detect errors in sections in which the alignment has already been made “definite,” much less to correct such errors.

Embodiments of the invention directly address the problem of lack of robustness with respect to unexpected events.

In one embodiment for acoustic model training, it uses a generalization of spoken term detection, that is, unanchored searches for network targets. However, the most important difference is not the more general search and matching procedure. The most important difference is that this search procedure is specifically used as a means to detect errors and to assist in the correction of those errors. Therefore, embodiments of the invention are able to achieve much more robustness than either the standard frame-by-frame dynamic programming based alignment or the standard spoken term detection. Similar unanchored searches may be done for any other form of model-based pattern recognition.

A couple of concepts will be important for understanding the procedures in embodiments of the invention. They will be defined for embodiments specific to speech recognition, but similar definitions could be used for model training or recognition of other kinds of patterns.

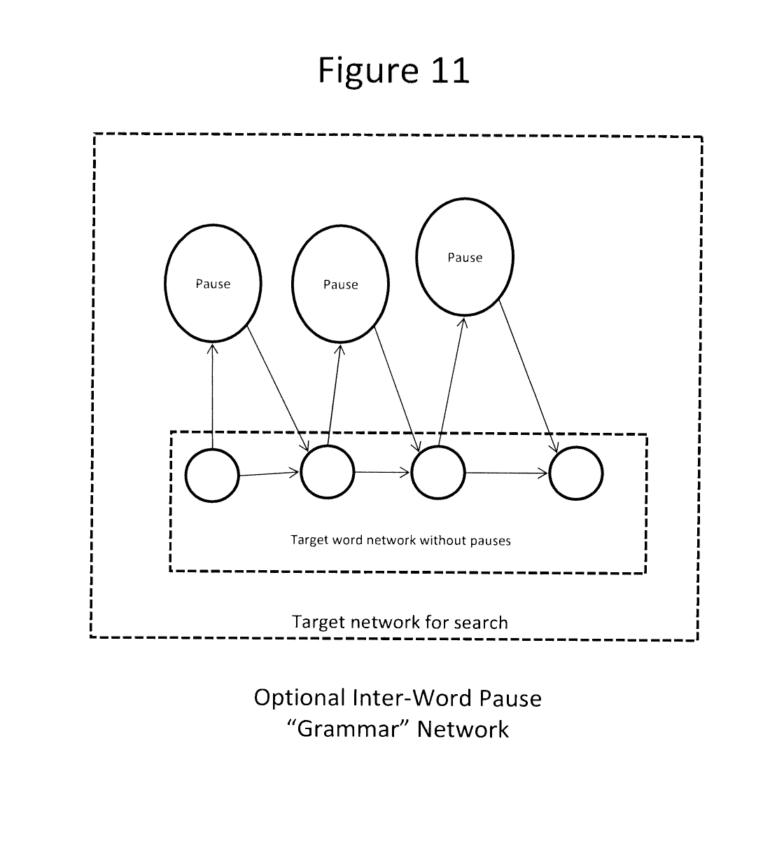

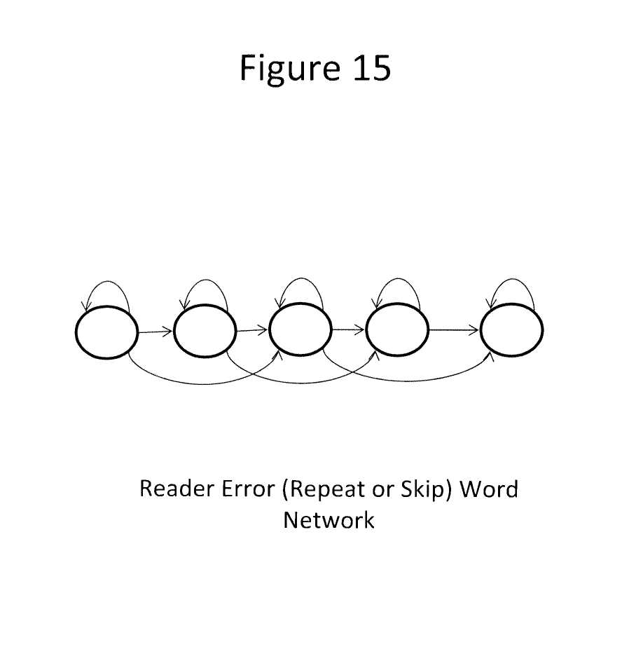

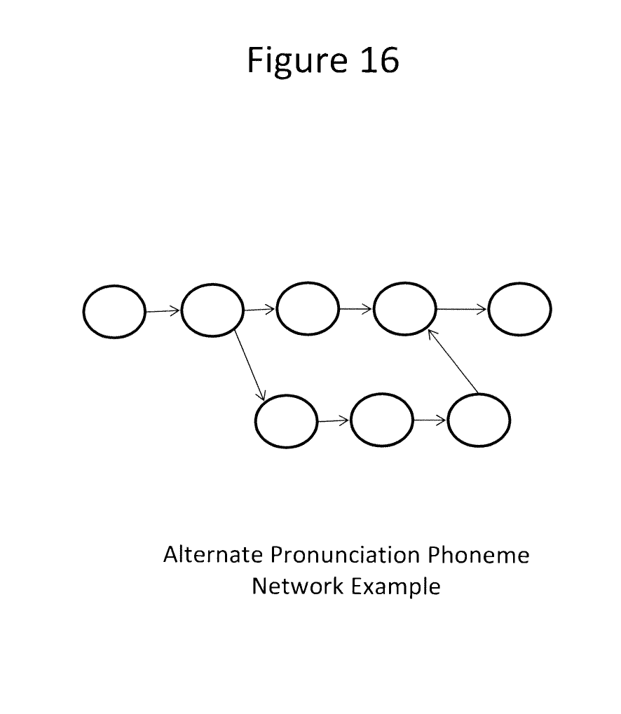

A script is a finite state network representing the available knowledge about the speech sounds that occur in the audio data stream. In the simplest case, a script is a known sequence of words (a normal representation of a script in text form), with a known single pronunciation for each word. A script represented as a network is more general. It can represent that after each word there might or might not be a pause (see FIG. 11). It can represent that some words have more than one possible pronunciation (see FIG. 16). Finally, it can represent known variations in the word sequence, for example the digit sequence “123” might be spoken as “one two three” or as “one hundred twenty three”. It can also represent errors that a person reading a script is most likely to make (see FIG. 15). The procedures of embodiments of the invention have been designed to handle a script network of arbitrary complexity, although generally a script network will not be very bushy and will have only a small number of alternative paths at any point in the network. Because embodiments of the invention can handle an arbitrary network as a “script” it can be used for recognition as well as for alignment.

An anchor point is a pair associating a node in the script network with the corresponding time in the audio data stream. If probabilistic estimates are being used, an anchor point may represent the estimated time as a probability distribution of times, rather than as a single point in time.

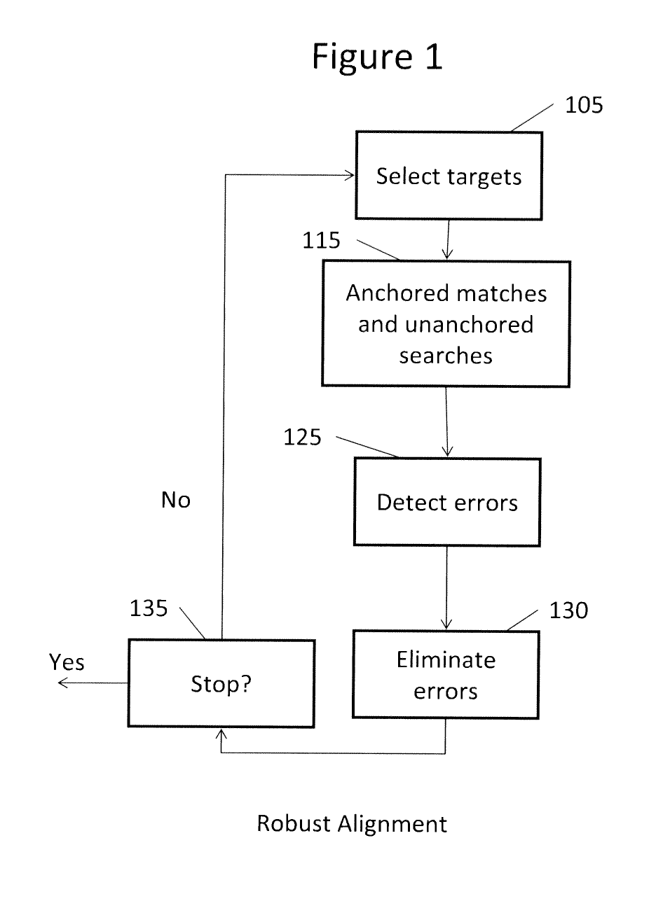

The procedures for computing a robust alignment will be explained with reference to the FIGS. 1 to 8, with network examples and process sketches in the remaining figures.

FIG. 1 is a flowchart of the overall process for robustly computing an alignment between a nominal script or constrained recognition network and a data feature sequence that may include unexpected events. The “script” may be represented by an arbitrary network or hidden Markov process, so the procedure of FIG. 1 may also be used for robust recognition. In particular, the error detection and correction capabilities of embodiments of the invention are particularly useful for an application in which the speaker is intended to follow a highly constrained grammar or language model, but in which the speaker may actually deviate from that constrained model.

The process of FIG. 1 repeatedly executes a loop until a stopping criterion is met. The stopping criterion may be that the process has analyzed the entire audio data stream and that no detected errors remain open for further analysis.

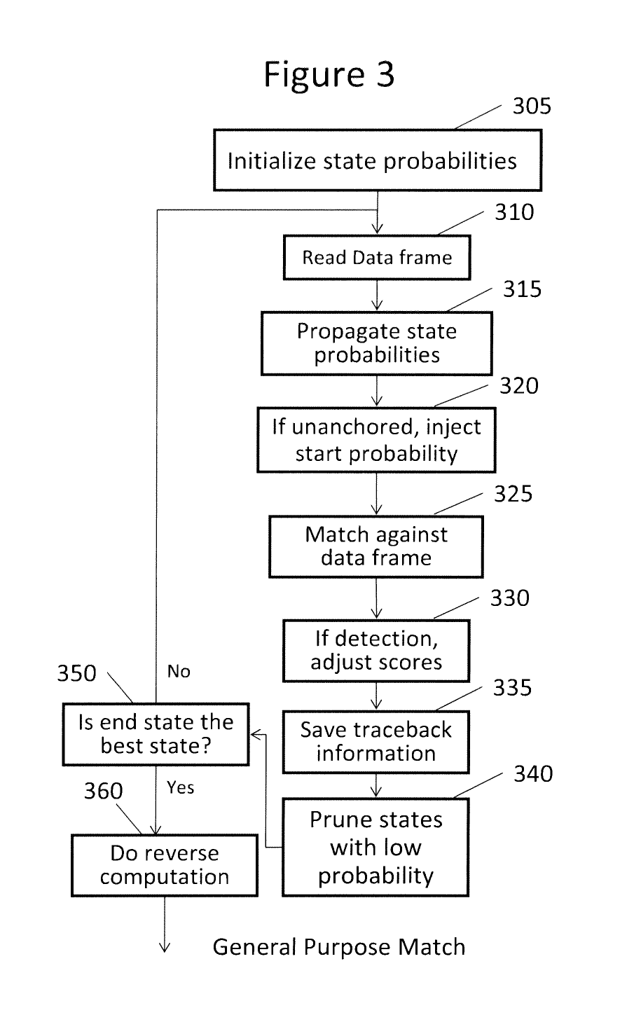

Block 105 begins the process and each pass through the loop by selecting one or more targets to be detected by either an anchored match or an unanchored search. For brevity, when discussing both anchored matches and unanchored searches collectively, they may both be called “searches”. In particular, in some embodiments, the match computation also makes an accept/reject decision similar to the accept/reject decision that is at least implicit in any unanchored search. Furthermore, in some embodiments there is a score adjustment made in the dynamic programming computation shown in FIG. 3 to aid in this accept/reject decision. This score adjustment may be made in anchored matches as well as in unanchored searches.

In one embodiment, block 105 begins the first pass through the loop by selecting as a target an initial portion of the script for an anchored match. In this embodiment, for the first time through the loop, the anchor is the beginning of the data feature sequence paired with the initial node of the script network.

In some embodiments, the length of the script portion selected as a target is chosen to make the detection or accept/reject decision reliable while not doing any unnecessary computation. The target should be long enough to have sufficient evidence for an accept/reject decision, but should not be so long that it significantly increases the risk of having an unexpected event occur within an instance of the target. In some embodiments, a reasonable length for a target is a few words, comprising about six syllables or about twenty phonemes. On the other hand, the error detection and error correction capabilities make the procedure robust against both missed detections and false alarms, so the choice of length of the target is not critical.

In some embodiments, block 105 may also select one or more targets for unanchored searches and may also select one or more targets for anchored searches in later passes of the loop after several anchor points have been located. The primary reason for selecting additional targets is to provide redundancy to enable error detection and error correction.

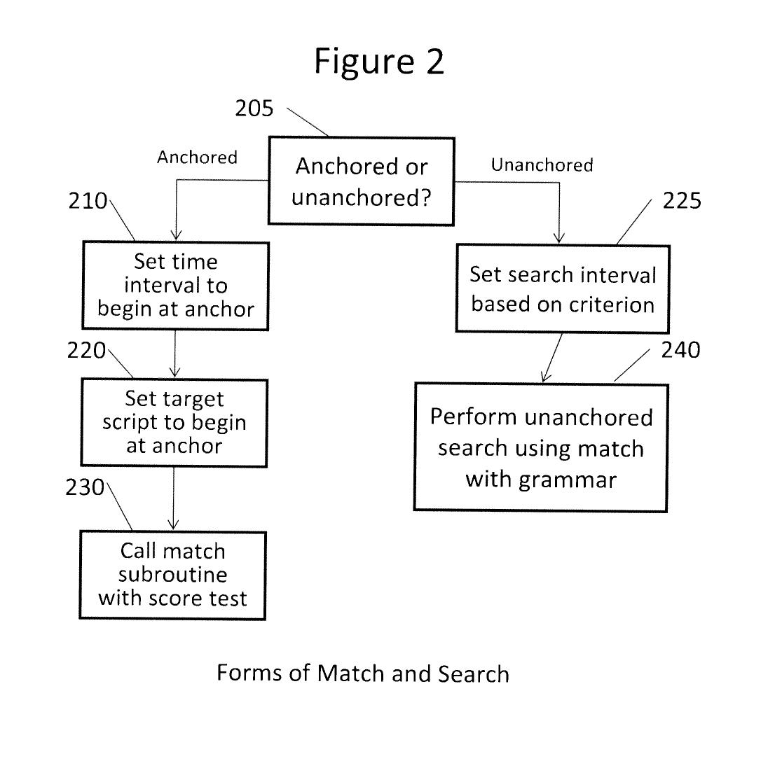

Block 115 performs the anchored matches and unanchored searches selected by block 105. Further details of one embodiment of setting the search conditions are described in association with FIG. 2. Further details of the frame-by-frame dynamic programming match computation, which is used both for anchored matches and for unanchored searches as well as in the error detection and error correction processes, are discussed in association with FIG. 3.

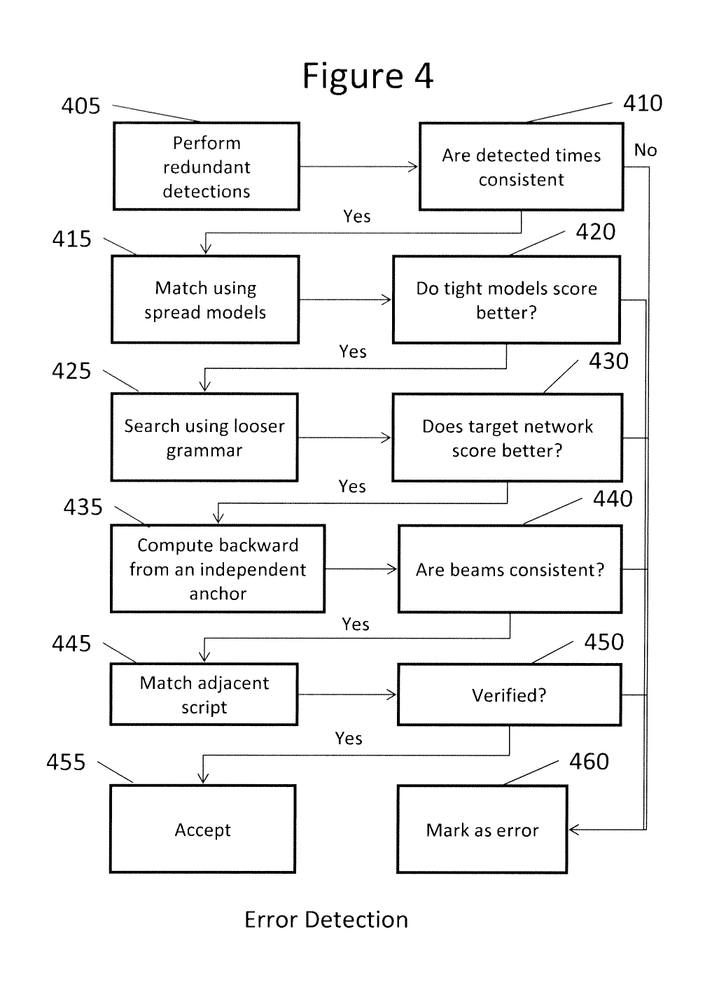

Block 125 then attempts to detect any errors. There are several kinds of errors that block 125 must attempt to detect: It must attempt to detect any alignment error made by the match computation done in block 115 itself; if block 115 does an anchored match, then block 125 must attempt to detect if the anchor point itself is in error; if block 115 does an unanchored search, then block 125 must attempt to detect whether the search has found it at the correct location and it also must attempt to detect if there are any errors in the alignment of any potential internal anchor points; and block 125 also must attempt to detect if the speaker deviates from the script. The procedures for detecting these errors are described in the discussion of FIG. 4.

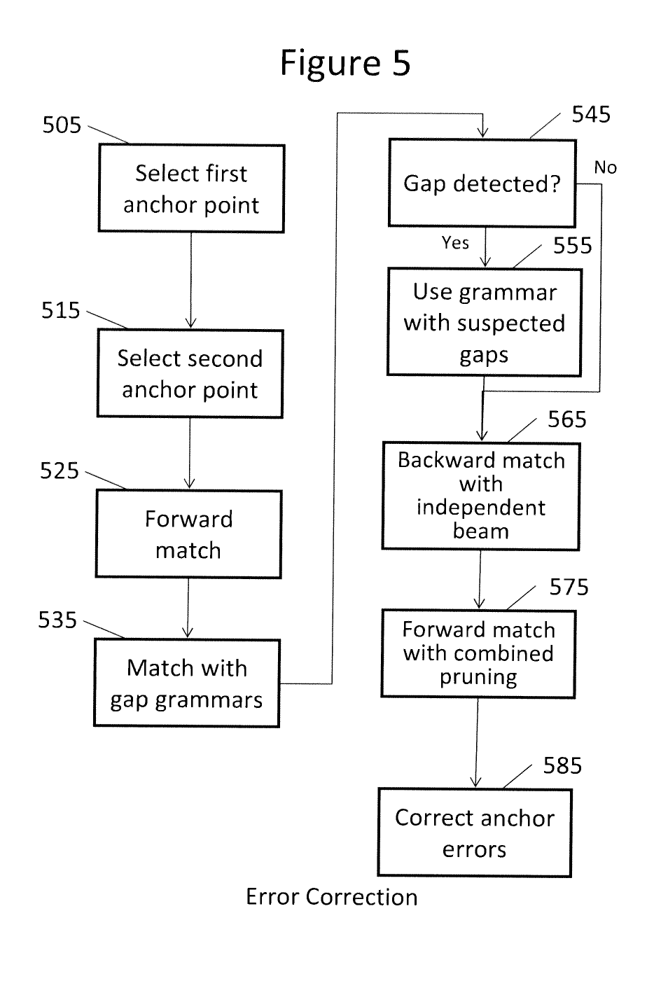

Block 130 then attempts to either correct the detected errors or eliminate them and any harmful effects they might have. For example, if the error is merely that an anchor point has been associated with the wrong time, in one embodiment Block 130 corrects the time, and any computations dependent on the wrong time would be redone. However, if it is detected that there is a period of time when the speaker says something that does not match the script, then in some embodiments Block 130 merely tries to isolate this time interval while computing the correct alignment for the surrounding feature sequence and script. More details of the error correction and elimination process will be discussed in reference to FIG. 5.

In one embodiment, the alignment is mainly done by anchored matches, and the unanchored searches are only used for error detection and correction. In this embodiment, the alignment begins at the beginning of the script and the beginning of the feature sequence. If no errors are detected, the process proceeds section-by-section in a monotonic fashion through the audio data stream.

In some embodiments, as will be seen in the detailed discussions in reference to the other figures, the processing does not necessarily proceed in a linear fashion through the script and the feature sequence. The error detection and error elimination processes proceed both forwards and backwards, and much of the robustness is achieved through redundancy by analyzing a given feature subsequence more than once and in more than one way.

Therefore, in one embodiment block 135 does not stop the loop until the analysis is regarded as complete. That is, there should be a detected anchor point that associates the end of the audio with the end of the script (or an earlier point if it is determined that the final portion of the script does not match the audio) and there should be no errors that have been detected but not dealt with.

A section-by-section implementation of the standard frame-by-frame alignment computation can be done as a special case of the process shown in FIG. 1 in more than one way: either the script or the audio can be broken up into predetermined sections, the sections can be aligned one-by-one using anchored matches, and the alignments of the sections can be concatenated to produce the overall alignment.

If, in a given pass through the loop, no targets are selected except the anchored match from an anchor from the end of the previous section, then no error detection can be done in block 125 and, therefore, no error correction in block 130.

If there are no errors, an alignment could be completed without selecting any extra targets in block 105, but, such an eviscerated version of the procedure in FIG. 1 would not be able to detect any errors if they should occur. However, this section-by-section dynamic programming based alignment works very well most of the time. Therefore, one implementation of the invention is to use the section-by-section frame-by-frame dynamic programming alignment as the core computation, usually proceeding section-by-section through adjacent concatenated sections so long as there are no errors, but on at least some of the passes through the loop selecting additional targets in order to detect whether an error has happened since the last error detection test.

As has been said, the optional additional target searches done in block 105 are to provide information for error detections in block 125 and to assist in error corrections in block 125. To increase the redundancy and error detection capability, in some embodiments these additional targets are selected to differ from the primary target is several different ways. An unanchored search, for example, is performed over a specified time interval. To detect different kinds of errors, the target may be selected from a place in the script that is either before or after the primary target. A secondary target may even be the same as the primary target because an unanchored search may find an instance of the target at a different point in time. An unanchored search may be in a time interval that starts either before or after the primary match or search and that may end either before or after the primary match or search.

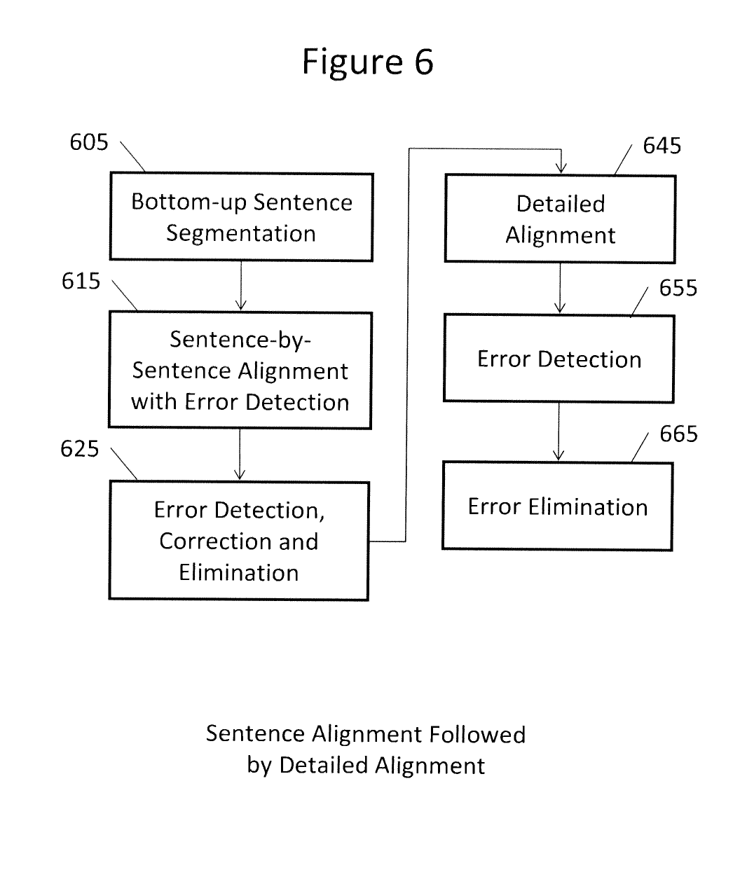

Other implementations of this invention will attempt to achieve more computational efficiency by performing searches in block 105 that skip around in the feature sequence, and do not proceed strictly section-by-section. These searches may either be unanchored or may be anchored somewhere other than at the end of the previously processed section. Such implementations will be discussed in more detail in reference to FIGS. 6, 7 and 8.

Block 105 performs one or more searches for one or more targets. FIG. 2 is the flow chart corresponding to one such search.

Each target is a hidden Markov process represented by a finite state network. A detection of an instance of a target consists of finding a match between a path in the network to a subsequence of the sequence of features. The path goes from a designated initial node to a designated final node. It corresponds to a state sequence in the associated hidden Markov process. A match is accepted as a detection if it satisfies specified criteria such as it match score being better than a give threshold. The hidden Markov process could represent a single word, a sequence of words or an arbitrary grammar that could represent many different word sequences, even infinitely many. Using hidden Markov processes as search targets, rather than only simple scripts or linear networks, provides efficiency and great flexibility. In particular, a single network can represent many different word sequences, with optional inter-word pauses (see FIG. 11), and alternate pronunciations for each word (see FIG. 16). A network can also represent potential deviations from the script, such as a speaker deleting a word or repeating a word or phrase (see FIG. 15). These network representations will be discussed in more detail in reference to FIGS. 11 to 16.

Block 205 determines whether a particular search is to be anchored or unanchored.

Consider first an anchored search, also called an anchored match, proceeding to block 210.

In the implementation of the section-by-section procedure described as an example in reference to FIG. 1, if no error has been detected, at least one of the searches performed by block 105 will be an anchored search, with the anchor being the end of the previous section, which is the same as the beginning of the new section. However, in other implementations, this anchor is not necessarily used, and, in any case, other anchored searches may also be performed in addition to unanchored searches.

Thus the anchor point referred to in block 210 is not necessarily the end of one section and the beginning of the next. It may be any node in any network that has been or can be associated with a particular time. Thus, it can be any node of any previously detected target or the time of any bottom-up detected acoustic event that can be tentatively associated with a potential target network, as discussed in reference to FIGS. 6, 7 and 8. For example, an anchor point could be a pause that is a potential end-of-sentence break that can be putatively associated with a sentence boundary even if neither the end of the previous sentence or the beginning of the following sentence have yet been detected as targets. An embodiment that uses such anchor points is described in association with FIG. 6.

Block 220 selects the target to be detected. The target will be a portion of the script network beginning at the script node associated with the anchor (or ending at the anchor if the search is to be done backward in time). As described in association with block 105 of FIG. 1, in some embodiments the typical length for anchored search is about six syllables or about twenty phonemes.

An anchored search is a specialized kind of search because the putative beginning time (or ending time if the frames are processed backward in time) is already specified by the anchor. However, like an unanchored searched, it must decide whether or not an instance of the target occurs at the specified time. In this it is like a specialized search or detection. In one embodiment, this detection decision can be done by a slightly modified version of the match computation as done for alignment. Thus an anchored search can also be viewed as a specialized match computation. In effect the detection criterion is whether or not the specified target matches well against the acoustic data stream starting from the specified time. As will be described in more detail in the discussion of FIG. 3, the same subroutine can do the computation for either purpose, so block 230 calls the match subroutine, and also has it perform an additional computation on the scores to decide whether or not there has been a detection.

In one embodiment that has been described, an anchored search results from creating an anchor point at the beginning of the current section from an anchor point located at the end of a previous section. That is not the only source for anchored searches or matches. In some embodiments, the sections may be deliberately overlapped by choosing an anchor point earlier than the end of the previous section. In some embodiments, the match may be computed backward in time from the anchor point, rather than forward. One reason for performing the types of anchored searches just described is to obtain redundant information to help in error detection, as explained in more detail in association with FIG. 4. Unanchored searches may also be performed by block 240 for similar purposes.

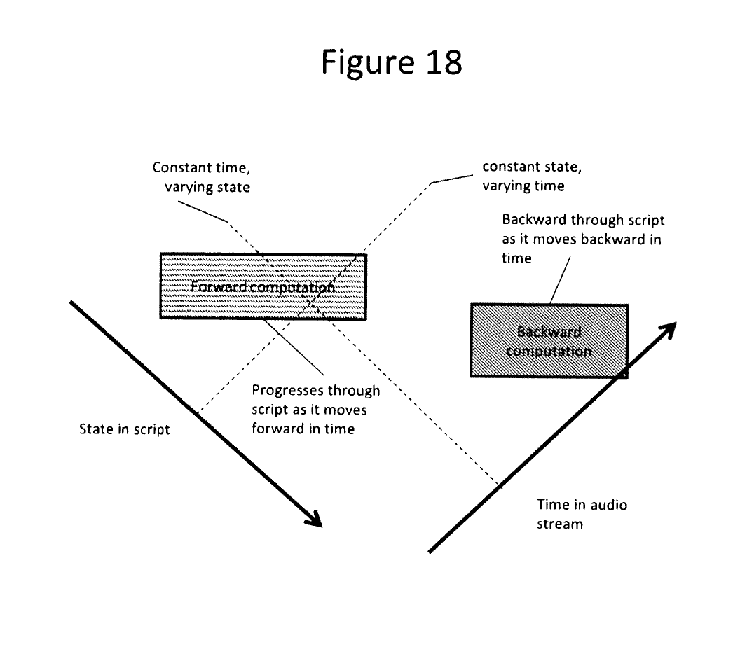

A backward match may also be used for error correction, as discussed in association with FIG. 5 and further illustrated in FIGS. 18 to 23.

Other embodiments implement anchored searches with different targets. One embodiment, for example, does not take the usual section of the script network, but rather expands that network to include additional word or phoneme sequences. The purpose of this search is to discover whether a different sequence might match the acoustic data stream better than the normal target network. Such an expanded network may also be used for an unanchored search in block 240.

Another embodiment may use either the same target network or a different network, but in either case it uses different models for the conditional probability of the acoustic features. In particular, in one embodiment, probability distributions are selected that spread out the probability distribution across a broader region of acoustic feature space. This spread may be accomplished, for example, by increasing the variance in a Gaussian model, or by increasing the separation of the means in the component distributions of a mixture distribution. It may also be accomplished by substituting speaker-independent models or models less adapted, for speaker-dependent or more adapted speaker-adaptive models.

The purpose of an anchored or unanchored search with a target with such spread out probability distribution is to detect errors made because the current models are overconfident and, like Socrates' contemporaries “don't know what they don't know”. In particular, an unexpected event may get a relatively poor score from the current models and the match of the more spread out models may get a better score. When the spread models get a better score, it does not always mean that there is an alignment error. Indeed, the two versions of the model may agree on the alignment. However, whether they agree or not, the more spread out model scoring better means that there was an at least somewhat unexpected event. Therefore additional analysis is warranted to verify or dismiss the suspicion of a possible error. In some embodiments, additional anchored and unanchored targets are selected from nearby portions of the script network and nearby or surrounding time intervals.

When the anchored search or match computation of block 230 is complete, that also completes one execution of FIG. 2 within block 115 of FIG. 1. Block 115 executes the procedure of FIG. 2 for each of the selected targets and then proceeds to block 120.

In reference to the other choice in block 205, it may be determined that the search to be performed is unanchored, so the procedure goes to block 225.

Block 225 selects the time interval that is to be searched for the best matching instance of the selected target. To understand the selection of the time interval for an unanchored search, it is necessary to understand the purpose of the particular unanchored search.

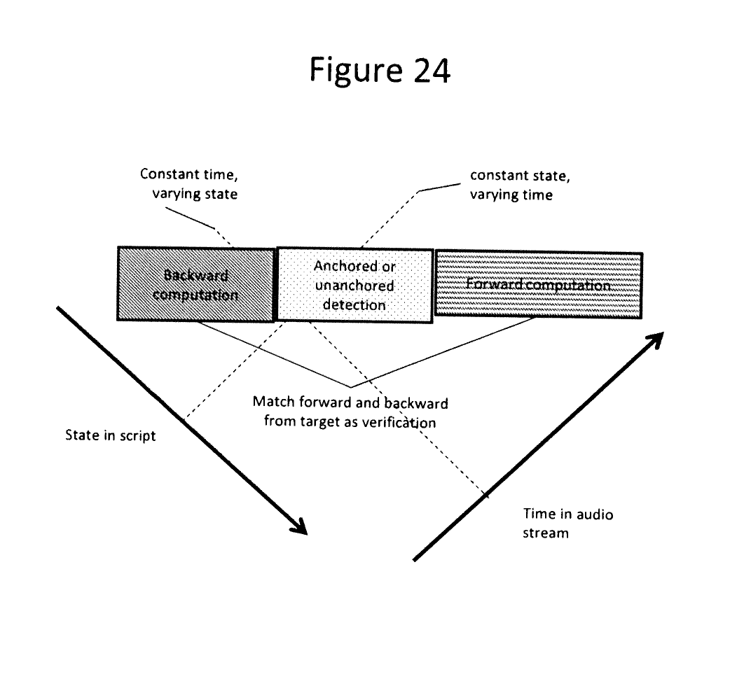

One of the reasons for unanchored searches is to provide additional information to aid in error detection. For this purpose, most embodiments optionally select additional targets in block 105 of FIG. 1. An unanchored search is performed to model that the time location of the target is not known. One reason that the time of a target would be modeled as not known would be that the hypothesis is being explicitly explored as an alternative to an anchored search or match at a specified time. Detection of such a target creates a hypothesis that the anchored match is located at the wrong time. This hypothesis of an error in alignment is easily tested. In addition to comparing the match scores at the anchored time and the detection time, each hypothesis can be further tested by matching additional portions of the script forward and backward in time from the respective detected targets, as illustrated in FIG. 24. In the spirit of Socratic agent delayed-decision testing (see U.S. Pat. No. 8,180,147), these hypothesis tests may be continued until the score difference between the two hypotheses is statistically significant.

The comparison would only need to be terminated before a decision if the continuations of the respective hypotheses forward and backward in time both reach points before and after the targets such that the two hypotheses agree on the alignments beyond those points. In that case, the poorer scoring hypothesis represents a temporary, correctable misalignment. Even though the difference in score may be less than statistically significant, in such a case the better scoring hypothesis may be safely chosen in some embodiments. The better scoring hypothesis will agree with the alignment that would have been found if a full forward and backward alignment computation had been done without beam pruning. For our purposes, that is the definition of an alignment being correct, because it is has the best score of all possible alignments under all knowledge presently available.

Another reason that the time of a target would be unknown would be that the script network of the target has been selected from a later or earlier portion of the script. In some embodiments, such a target may be selected to provide redundancy and, thereby, consistency checks to aid in the detection of errors. This form of error detection will be discussed further in the consideration of FIG. 4.

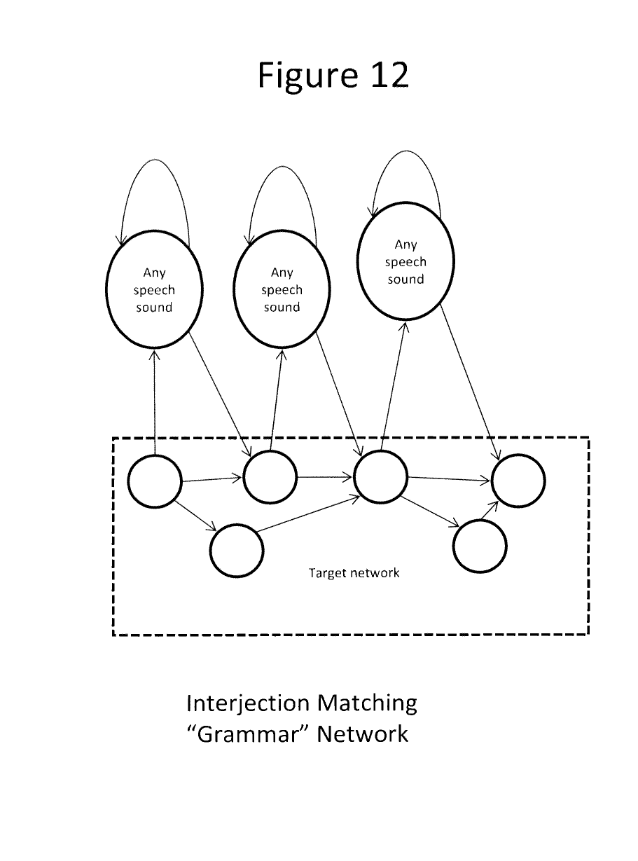

A further reason for the time of a target to be modeled as unknown is that the target is an expanded network representing additional word and phoneme sequences as wells as a normal target, as described in the discussion of block 230 and in the discussions of FIGS. 12 to 15. Sometimes only an anchored match of such an expanded network would be desired, but some embodiments will sometimes select an unanchored search.

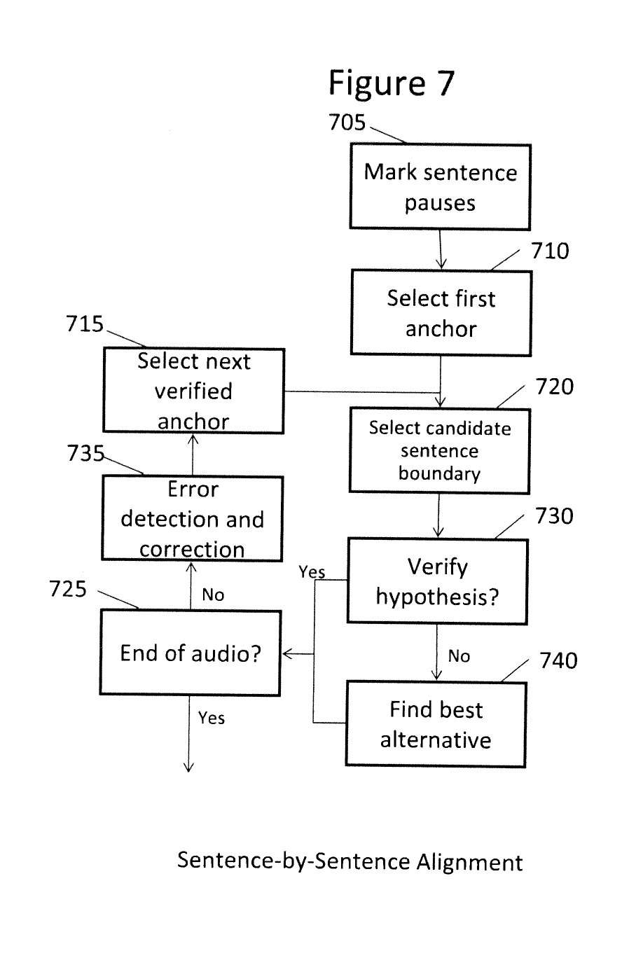

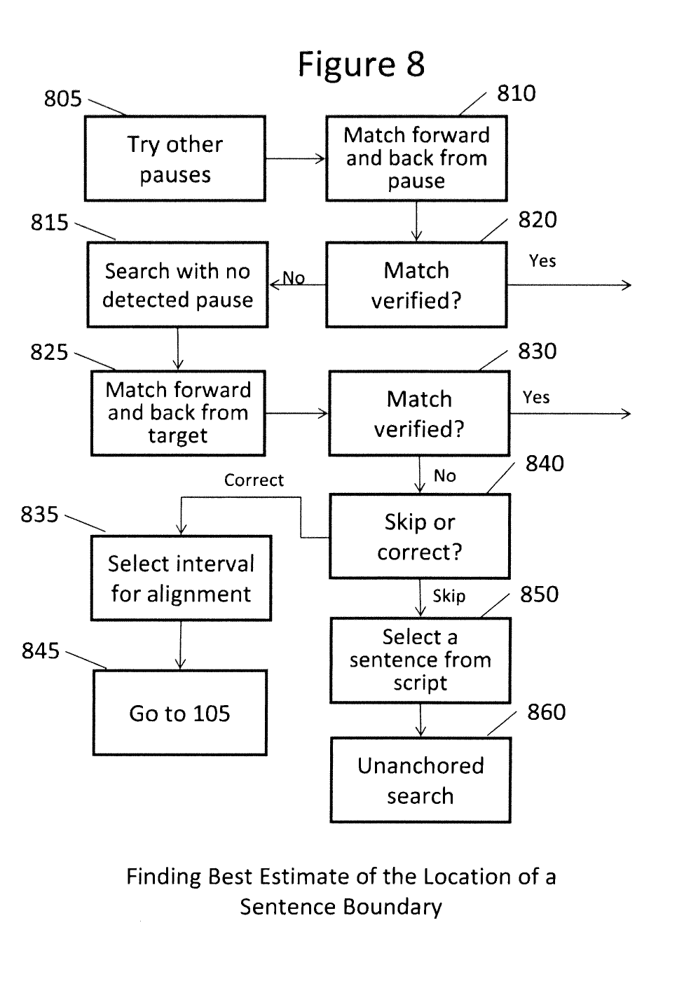

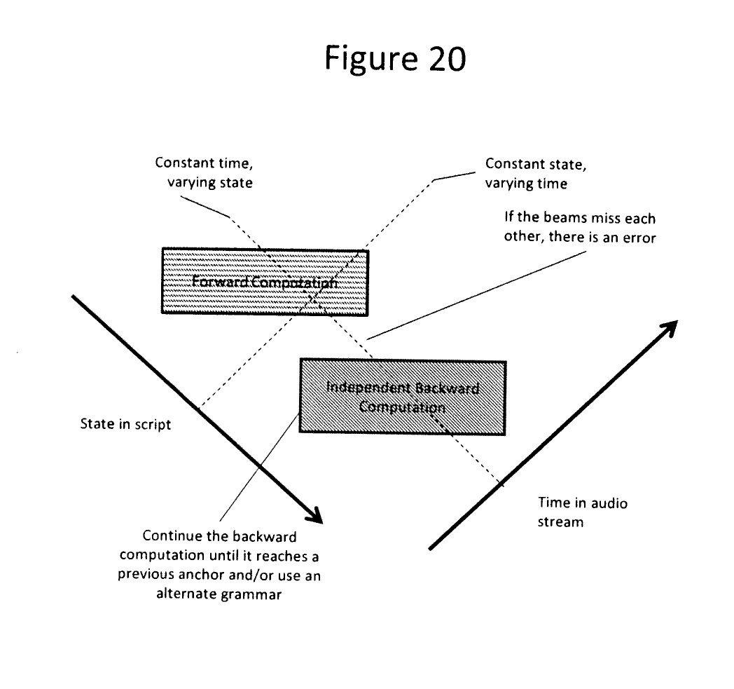

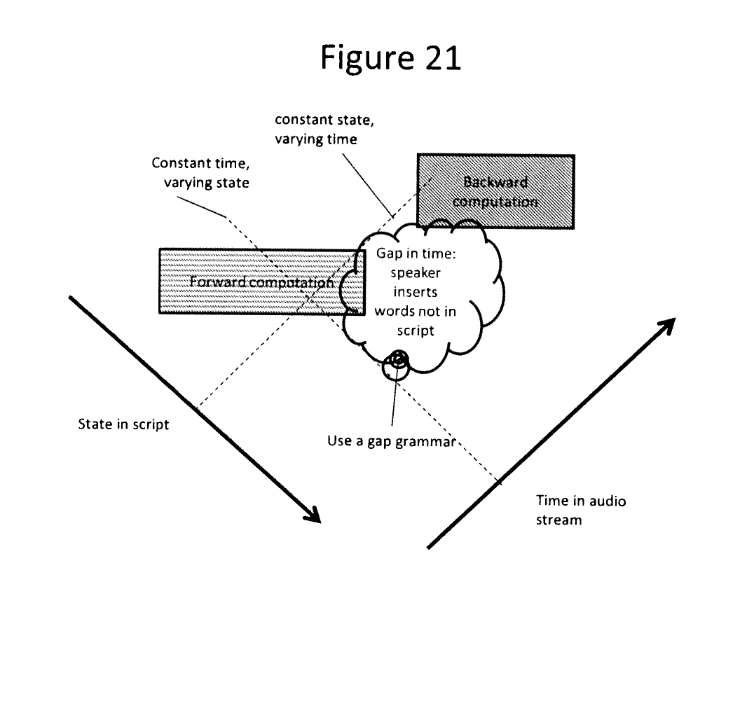

Another reason for an unanchored search is specifically to locate a future event. One reason for locating a future event is to create an anchor point for a backward computation, such as used for error detection in 435 of FIG. 4 (as illustrated in FIG. 20), and as used for error correction in block 505 in FIG. 5 (as illustrated in FIGS. 21 to 23), and for hypothesis verification as in block 730 of FIG. 7 and blocks 810 and 825 in FIG. 8 (as illustrated in FIG. 24).

An unanchored search may also be performed in order to determine the time of occurrence of a specified target from the future portion of the script network. In some embodiments, such a target is selected for detection to enable the process to skip ahead in the feature sequence to save computation. If the amount of the script network that is being skipped is substantial, it may be necessary to search a very long time interval. There is a danger that in such a long time interval an instance of a similar phoneme sequence or even another actual instance of the target network may occur within the selected time interval. This danger can be reduced by choosing a long target and by searching the script network to make sure that that are no other identical or similar sounding portions elsewhere in the script. If a target appears likely to be error prone, a different target can be selected. In addition, before using a detection of such a target as an alignment anchor, it may be verified by matching adjacent portions of the script to adjacent portions of the feature sequence, as illustrated in FIG. 24. Furthermore, one embodiment avoids all these dangers simply by never using this form of unanchored search to set anchor points. An efficient and safer means of reducing computation is described in connection with FIGS. 6, 7 and 8.

For any or all of these reasons, some executions of block 105 in FIG. 1 may select some unanchored searches in addition to any anchored searches of matches that are selected.

In addition to the selection of the target network, an unanchored search also requires a selection of the time interval to be searched, which will depend on the purpose of the search and the criterion for detection, so one of the tasks of block 225 is to specify this time interval.

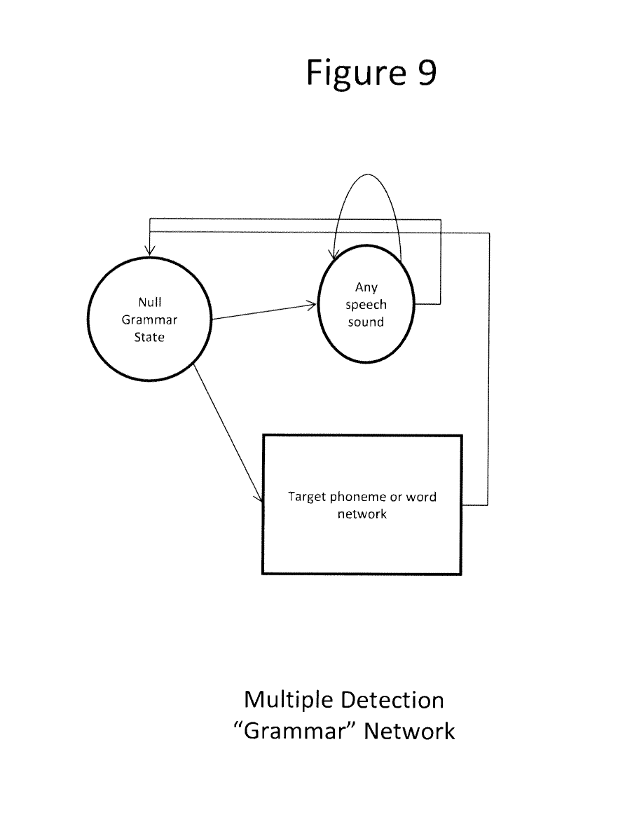

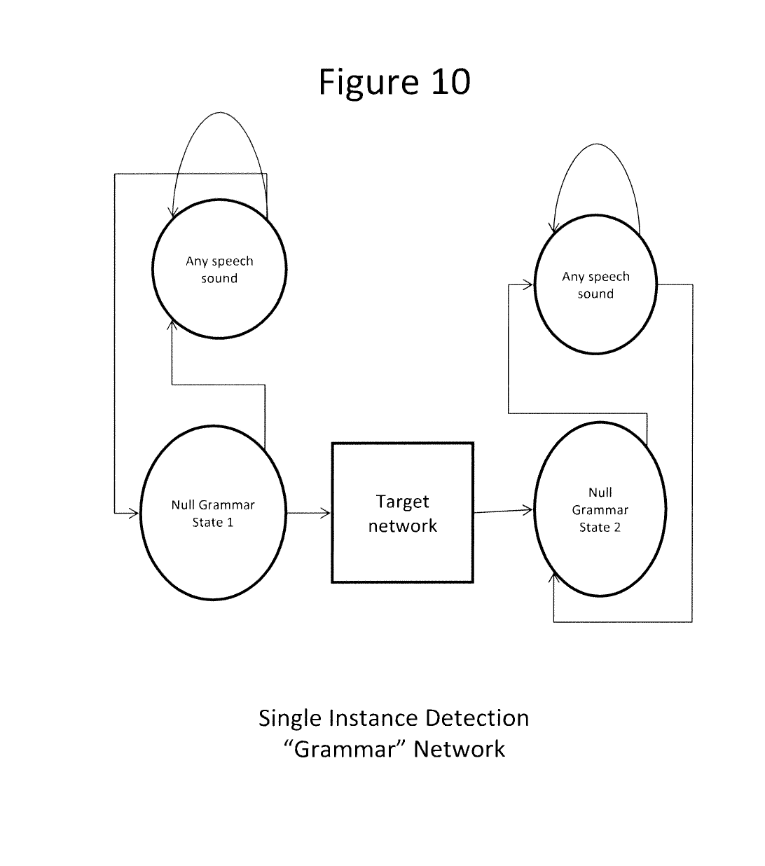

To understand the issues involved in block 225 selecting the time interval, the implementation of an unanchored search must also be discussed. The computation performed in an unanchored search is similar to the computation performed in spoken term detection. As explained in relation to FIGS. 9 and 10, the small differences in the computation between a conventional spoken term detection and the embodiments of unanchored search in this invention create major differences in the behavior of an unanchored search and in how it is used in embodiments of the invention. An unanchored search as used in embodiments of the invention has completely different properties than a standard spoken term detection with regard to missed detections and false alarm rate.

In particular, an unanchored search as implemented in FIG. 10 always detects one and only one instance of the specified target. In contrast, a conventional spoken term detection computation sometimes makes no detection (or misses the correct detection) and sometimes makes one or more false detections. The Gap alignment procedure of U.S. Pat. No. 7,231,351, for example, computes the gap between the score of the best scoring detection and the second best scoring detection, which of course always requires that there be at least two detections, even though at most one of them is expected to be correct. (Note, the word “Gap” in this reference refers to a gap between two scores, but in this disclosure the word “gap” usually refers to a gap in the alignment of the script to the audio data stream where the gap is an audio section that is skipped because it is detected that the speaker deviated from the script.)

The unanchored search based at least in part on the grammar shown in FIG. 10 finds the best matching instance of the target whose starting time is within the specified search interval. Some embodiments may also restrict the ending time for any detected instance. Since a best instance is always detected, there are no missed detections, unless something is already in error. In conservative embodiments that do not attempt to jump far ahead in the script, there also are essentially no false alarms or detections at the wrong time, unless the search is based at least in part on an alignment that is already in error and the search interval is too short to contain the correct location of the target.

In embodiments of the invention, unanchored searches are mostly used for redundancy and error detection rather than as the primary means of alignment. Furthermore, in some embodiments, for example both in the embodiment mentioned in the discussion of FIG. 1 in which the core computation proceeds section-by-section and in the sentence-based embodiment illustrated in FIGS. 7 and 8, the detection from an unanchored search is never used as an alignment anchor, except when it is used as part of an explicit and verified error correction procedure.

Thus, even when an error in the alignment causes a false detection in an unanchored search, in these embodiments, that false detection will not be able to propagate the alignment error. In fact, just the opposite will be true. Because the time interval to be searched will usually be very short, there will usually be no portion of the time interval that is a reasonable match for the target of the unanchored search. Therefore, the best matching instance will have a very poor match score. As a consequence, rather than propagating an alignment error, an unanchored search that results in a false detection will almost always detect and report the fact that there must have been a precursor alignment error.

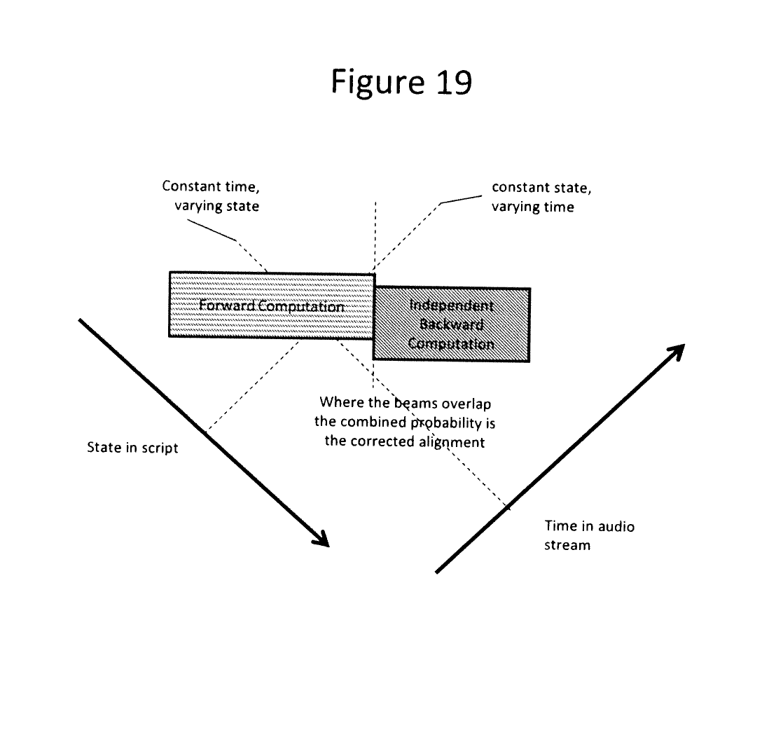

As will be seen in the discussion of the backward computation, any correct detection of an unanchored target will also detect whether or not its preceding anchor point is in error (as illustrated in FIGS. 19 and 20). Thus almost all alignment errors will be detected by any associated unanchored search. First, almost all the time the selected search interval will be sufficient to correctly detect the correct location of the target of the unanchored search. Then the backward computation will detect and correct the error. Second, even when the search interval does not contain the correct target, the best match for the target will almost always be poor, so the error will still be detected.

Thus, either way almost any unanchored search will detect if its preceding anchor point is in error by enough to cause block 225 to select the wrong time interval. Since multiple unanchored searches may be selected for a single alignment anchor, an alignment error could remain undetected only if all of those unanchored searches fail to detect it. If, in spite of all this, an alignment error is undetected and propagates to create additional alignment errors, once a later error is detected, a single backward computation can continue backward to discover all of the preceding alignment errors, as will be discussed in reference to block 435 of FIG. 4. Thus, embodiments of the invention are extremely robust against alignment errors. Nonetheless, as discussed in association with FIG. 4, in most embodiments additional means are used for detecting errors besides the ones discussed in this paragraph.

Still referring to block 225, the selection of the time interval for an unanchored search with a network such as the one shown in FIG. 10, is based at least in part on the property that an unanchored search always finds the best matching instance of the target in the specified time interval. It is also based at least in part on the purpose of the particular unanchored search, which is usually to detect a potential error in a preceding alignment anchor. However, the selection of the time interval also depends on properties of the selected target network.

Usually, the target network will be a portion of the script network that corresponds to several words comprising, say, six or more syllables and twenty or more phonemes. With a target of such length, there will be very few cases in which some other word sequence results in a phoneme sequence that is very similar to the target. This possibility will be reduced further if the time interval to be searched is relatively short. In some embodiments, this possibility is reduced even further by checking the script to see if there are any nearby portions of script that sound similar to the candidate target. If there are any, the particular candidate target may be set aside and a different target may be used for the unanchored search.

Another consideration for block 225 is that an unanchored search will generally have a gap in the script network between the grammar node corresponding to previous alignment anchor point and the first grammar node in the target network, otherwise an anchored match would usually be performed rather than an unanchored search. However, as explained in reference to block 230, sometimes an unanchored search is performed in addition to an anchored match for a network with no gap, for redundancy.

The time interval for the unanchored search must be selected to cover the estimated time delay due to the part of the script that is skipped and to cover the amount of uncertainty in that estimate. With a larger gap, a search interval must not only reflect the delay, but the duration of the search interval must also be longer to cover the uncertainty. On the other hand, a shorter search interval is less likely to have another phoneme sequence that by chance happens to be similar to the target.

Therefore, in some embodiments, in particular those that mostly extend the alignment anchors section-by-section, most of the routine error-detection unanchored searches leave a relatively small gap, say one to three words or no more than say six syllables, between the grammar node and the first node of the target network. On the other hand, variety leads to diversity and redundancy, so in most embodiments some targets with longer gaps are also selected.

Because the backward computation can detect and even correct errors in multiple alignment anchors that are in error (see block 435 for FIG. 4 and block 525 of FIG. 5), and because the anchored searches or matches can also detect alignment errors, it is not necessary to use an unanchored alignment search for every section or every alignment anchor. Some embodiments use fewer unanchored searches in order to reduce the amount of computation. Some use more only if one or more errors have already been detected, since that is an indication of difficulty with the particular feature sequence being aligned.

The length of the search interval may also depend on easily detected acoustic events, especially if those events are likely to affect the time delay until an instance of the target. In particular, any speech pauses or intervals of silence within a tentatively proposed time interval should be detected and the time interval should be correspondingly extended.

Continuous speech without such pauses typically has about 4 to 7 syllables per second. Therefore, with a gap in the script network of around six syllables there will be an estimated delay of about one second. A time interval of ten seconds, extended if there is a long pause, should be more than adequate not only to cover the delay until the instance of the target, but also to cover and correct a previous error in the alignment of up to say five seconds. Sometimes additional unanchored searches for the same target will be performed over different time intervals, for redundancy.

Different time intervals may be selected for unanchored searches with different purposes. Consider an unanchored search whose sole purpose is to provide a future anchor point from which a backward computation is to start backwards. For example, such a backward computation might be used to correct an error that has already been detected by some other means, such as a poor score in an anchored match and does not need to error detection but only error correction.

In some embodiments, the backwards frame-by-frame computation of a backwards match is very similar to the frame-by-frame computation of a forwards match computation, so the detailed discussion of both will be postponed until the discussion of FIG. 3. For the present discussion, it is only necessary to discuss how the backward computation is initialized and how the active states and their scores are determined. In one embodiment, this initialization is the main difference between the forward match computation and the backwards computation.

The difference in initialization results from the difference in what the forward and backward scores represent. In an embodiment in which the forward computation starts from a previously computed anchor point, the states scores are initialized to represent the probability of being in a particular state and of having made all of the acoustic feature frame observations up to the current time frame. The score may be the logarithm of the probability and may be normalized, but the point that is relevant to the current discussion is that the score represents a joint probability. The consequence is that the beam pruning in the frame-by-frame computation is done relative to the best scoring node in each frame. Therefore, the active beam going forward from a previously computed anchor point is the same as the active beam at the anchor point at the end of that previous forward computation.

A backward computation, however, is slightly different. The alignment computation is part of the acoustic model training algorithm called the Baum-Welch algorithm or, in a wider context, the EM algorithm. For the Baum-Welch or EM algorithm, the backward computation should represent a conditional probability, conditional on the ending state rather than being a joint probability with the probability of ending in the given state. These differences between the forward and backward match computations are discussed in more detail in reference to FIG. 3. This difference is often ignored because it only affects the initial scores for each state in the last frame.

However, when a backward computation is to be started up in the middle of an interval of speech as part of an alignment computation, it is important that the scores be consistent with the correct alignment and that they correctly represent conditional probabilities of starting backward from each state. Actually, initializing the backward conditional probabilities is very simple. Since initially no observations have yet been made, the backward conditional probabilities are initially all equal to one. Therefore, all that needs to be determined is what states should be included in the active beam, and all that really matters is whether the state corresponding to the correct alignment is included. Since the correct state is unknown, the set of active states should be made large enough to make sure that the unknown correct state is included.

One way to determine the beam of active states to initialize the backwards computation is to estimate which states might be active based at least in part on the active beam at the previous anchor point and the time delay in between. For the purpose of error detection or error correction, however, it is important that the initialization of the backward computation is not too heavily influenced by time of the anchor point or its active beam. One embodiment makes the initial beam of the backwards computation be very broad, that is to have many active states.

One embodiment is to initialize the active beam for the backwards computation not from the beam of the previous anchor point, but from the location of a target that is detected by an independent unanchored search. In one embodiment the backward computation is started at the end of the detected instance of the target using the active beam that was arrived at by the last frame of the detected instance. Then the backwards computation is performed back through the detected instance and then continued back to the previous anchor point, as explained in reference to block 525 of FIG. 5.

An unanchored search for this purpose is error tolerant because it has a built-in error detection mechanism. As the backward computation proceeds backwards past the beginning of the detected instance of the target, it will be matching not against data that was used in the detection of the target, but rather against new data that needs to match against the portion of the script preceding the target and going back to the previous anchor point. If the target has not been correctly aligned, the chance of this data matching that specific portion of script is very small. If such a mismatch occurs, the detected target instance is rejected, and a new unanchored search can be performed, either searching a longer time interval for the same target, or using a different target.

Because of this error detection and recovery mechanism, the selection of the time interval in block 225 for this type of unanchored search is not critical. If the same unanchored search target is to be the primary error detection search, then the same selection criteria as for an unanchored search for the sole purpose of error detection can be used. If the unanchored search is to be used only for error correction or at most for supplementary error detection, then a target may be selected with a larger gap in the script network. In some embodiments a larger gap may be preferred to give greater assurance that by the time the backward computation reaches the previous anchor point the backward scores will have little dependence on the initialization. A longer gap also further increases the effectiveness of the built-in self-error-detection of a backward computation from an unanchored search.

In summary, in most embodiments, block 225 may reasonably choose a time interval of say ten seconds, starting from the previous anchor point or the end, unless a target is selected with overlap, in which case the search interval starts at the earliest time at which an instance of the target is to be considered.

Once the search interval is set, block 240 performs an unanchored search. One embodiment or an unanchored search is to do continuous speech recognition using a specialized grammar. This embodiment may use the same frame-by-frame computations as regular speech recognition, which are also essentially the same as the frame-by-frame computations that may be used in acoustic model training and frame-by-frame match. These frame-by-frame computations will be discussed in more detail in connection with FIG. 3. The essential differences between these applications are in the grammars that are used. Some embodiments do not use a grammar represented as such, but achieve the same effect by having the equivalent of the grammar represented directly in the software.

Regardless of the implementation, for purpose of exposition, this discussion will describe all embodiments that achieve the effect of a grammar in terms of the grammar. The grammars that are used in the cases discussed are all finite-state grammars, so each grammar may be represented as a hidden Markov process. The computation represented in FIG. 3 can be used to match any hidden Markov process to a data stream of acoustic features. Therefore, this computation may be used to do recognition with a grammar as well as anchored match and alignment.

In one possible embodiment for unanchored search, the grammar is shown in FIG. 9. This grammar has a null grammar state, a state that can produce any sequence of speech sounds by looping back on itself, and a state that produces an instance of the target network. Both of the other two states return to the null grammar state, which represents the fact that the other two states can be repeated and intermixed any number of times without limit. It is also possible in this grammar for the sequence of speech sounds to be repeated indefinitely without a single instance of the target network.

The grammar network in FIG. 9 represents one embodiment for spoken term detection. In spoken term detection the target word or phrase might or might not occur in the audio data stream. If it occurs, it might occur anywhere, and it might occur any number of times. The grammar in FIG. 9 correctly represents the ignorance about how many times an instance of the target network might occur.

Notice also that the network in FIG. 9 allows an instance of the target network to be matched against the node representing any sequence of speech sounds. This creates a problem because it means that an instance of the target network can be misrecognized as just a sequence of sounds, which would correspond to a missed detection.

The only control over this source of errors is to adjust the transition probabilities in the corresponding Markov process, which in FIG. 9 correspond to conditional probabilities attached to the arcs. Since nothing could be recognized if any of these probabilities were set to zero, adjusting the probabilities will not eliminate the missed detections. Changing the probabilities will only trade-off between missed detections and false alarms. Furthermore, in practice the rate of missed detections and false alarms fluctuate due to many causes, and it is difficult to adjust the probabilities to keep the two rates in balance.

However, in the alignment application, the script is known. This provides much more information than is used in spoken term detection and much more information than is represented in the grammar illustrated in FIG. 9. In the alignment application, if a word in the text script is optional, or if there is more than one way to speak part of the script, those possibilities should already be represented in the script network. If a particular node in the script network is aligned to a particular time, then for any subnetwork in the script network that follows shortly after that particular node in the script network, there must be an instance of the corresponding target network in the audio data shortly after that particular time. If the target network occurs only once in the script network, there will be one and only one instance of the target network in the audio data stream. These facts are represented by the grammar in FIG. 10.

In FIG. 10, there may be any sequence of speech sounds, followed by one and only one instance of the target network, followed in turn by another arbitrary sequence of speech sounds. To match this grammar, an audio data stream must have one and only one instance of the target network. Recognition with this grammar will always detect an instance of the target network at the location at the highest probability location

Block 240 performs an unanchored search for the selected target network in the specified time interval by running a recognition against the hidden Markov process represented by FIG. 10. When block 240 completes the unanchored search, control returns to block 105 of FIG. 1, which will request any additional anchored or unanchored searches and then pass control to block 115.

FIG. 3 is a flowchart of the inner frame-by-frame process of matching a hidden Markov process to an feature sequence. With slight variations, this frame-by-frame matching can be used in both anchored matching and unanchored search, as well as for recognition (as described in association with blocks 230 and 240 of FIG. 2). Essentially the same computation running backward in time can be used for error detection and error correction (as described in association with block 435 of FIG. 4 and block 525 of FIG. 5). Running backwards, in one embodiment it may also be used for making a more precise estimate of the time of an anchor point that is not in error (as will be discussed in association with block 335 of FIG. 3 and as illustrated in FIG. 19). Some embodiments run additional forward frame-by-frame computations with varying characteristics for added redundancy and error detection (as discussed in association with FIG. 2 and block 105 of FIG. 1). In some embodiments, forward and backward frame-by-frame matches are computed to detect and localize intervals during which the speaker says something that doesn't match the script (as described in association with block 535 of FIG. 5, and as illustrated in FIGS. 21 to 23).

Note that there is increased flexibility and ability to represent expected alternatives because FIG. 3 is matching the acoustic data stream with a hidden Markov process, rather than just matching it to a sequence of words or a sequence of phonemes. In particular, in most embodiments, the network or hidden Markov process will allow an optional inter-word pause after each word, as shown in FIG. 11. Also, whenever there is more than one way to pronounce a word, the pronunciations can be represented by a network, such as the example shown in FIG. 16. In this example, there are two pronunciations, one with five phonemes and one with six. The two pronunciations share the first two phonemes and the last phoneme of the word. The ability to represent such alternatives, and to represent grammars, such as in FIGS. 9, 10, 12, 13, 14 and 15 will be assumed in all the discussions of the uses of the match computation in FIG. 3, whether specifically mentioned or not.

Block 305 initializes the state probabilities. How the state probabilities should be initialized depends on several things. First, it depends the initial knowledge. Second, it depends on whether the computation is to be with joint probabilities (usually performed forward in time) or conditional probabilities (usually performed backward in time), as will be discussed later. In some embodiments, the relationship between joint or conditional probabilities and time direction may be reversed. Third, the initialization depends on which form of match computation is to be used.

There are two main forms of the frame-by-frame match computation illustrated in FIG. 3. Each form computes a particular measure of how well the specified hidden Markov process matches a specified time interval of the feature sequence. In this discussion, the word “path” refers to a sequence of state values of the Markov process (a state value indicates what state the Markov process is in at a given time), which corresponds to a path through the finite network representing the Markov process. In the discussion of FIG. 3, any such path will be time-aligned. That is, the sequence of states values in the path will be associated with a time interval, with one state value for each time unit. If the Markov process stays in the same state for several time units, that would be represented by having that state value repeat in the sequence, corresponding to the number of time units.

One form of the match procedure finds, among all paths that wind up in a given state at a given time (see note in next paragraph about the search of “all paths”), a path that has the maximum probability, and computes that probability. In this discussion, this first form will be called the “best path” method. Another form of the match procedure computes the sum of the probability of all paths that wind up at a given state at a given time. This second form will be called the “sum of paths” method.

Note that, in most embodiments, neither method searches or sums all possible paths. Instead, states with extremely low relative probabilities are pruned and all paths that end in those nodes at the particular time are removed from consideration. Also, note that although the discussion will be in terms of probabilities, in many embodiments the likelihood of a given state may be represented by the logarithm of a probability rather than by the probability itself. Also, in some embodiments some approximation to the probability or log probability may be used. In some embodiments, a score may be used that isn't even intended to numerically approximate a probability, but that is a qualitative measure of likelihood. Although some of the details of the computation may differ, the basic structure of the computation shown in FIG. 3 can handle all of these cases.

With the exception of some embodiments, such as the one which will be discussed in reference to blocks 730 and 740 of FIG. 7 and block 820 of FIG. 8, an anchored match or search starts at an anchor point whose location has been determined by a previously computed match computation, even when the computation goes backward in time. That previous match computation will have had a beam of active states and a probability or score for each of those active states. In one embodiment, if the current form of the match is with joint probabilities, then block 305 initializes the current computation with the active beam and probability or score values from that previous computation. If the current form of the computation is with conditional probabilities, then the active beam is initialized from the active beam from that previous computation, but the active probabilities are all initialized to 1.0.

In some embodiments, if the anchor for an anchored match is selected without that anchor having been aligned by a previous match or search, then the set of active states is initialized by estimating the active states from a nearby anchor point or match computation, shifting the estimated beam to take account of the time difference and making the beam broader, that is, making more states active, to cover the uncertainty of the estimate. In one embodiment, if the anchored match computation is to be performed with joint probabilities, then the probabilities are all initialized to be one over the number of active states; if the match computation is to be with conditional probabilities, then all the probabilities are initialized to 1.0.

In some embodiments, the anchor for an anchored search may be determined by the direct detection of a specific acoustic event, rather than by a previous match or unanchored search. For example, in some embodiments of the process shown in FIG. 7, one or more anchor points are located by detected pauses in the acoustic data stream. In some embodiments, the set of active states is the set of nodes in the target network that are hypothesized to be related to the detected acoustic event. For example, if a pause longer that some specific duration is detected, it may be hypothesized to correspond to a sentence boundary, so it will be hypothesized to correspond to one or more nodes in the target network that correspond to sentence boundaries in the script. In some embodiments, there may be only one such node in the target network. For a joint probability computation, the probabilities may be initialized to 1.0 over the number of actives states. In some embodiments, if there is more than one node in the target network that is being hypothesized as corresponding to the acoustic event, then the probabilities are initialized to an estimate of the relative probability of the states, given the available information, such as nearby anchored or unanchored detections. For a conditional probability computation, the probabilities are initialized to 1.0.

In addition to representing the computation of either joint or conditional probabilities, the flowchart in FIG. 3 represents two types of the frame-by-frame match of a hidden Markov process to an acoustic data stream: a sum of probabilities computation or a probability of best path computation. In some embodiments, a computation is first done in one direction in time (typically forwards in time) and then done in the reverse direction in time. In the best path computation, the reverse computation just traces back through linked records to pick up the stored information about the state sequence along the best path. In the sum of probabilities computation, however, the reverse computation is also a sum of probabilities computation, and is also represented by FIG. 3. In most embodiments, the first computation computes joint probabilities and the reverse computation computes conditional probabilities. In one embodiment, the reverse computation does not determine its own active beam, so block 305 initializes the active beam to be the same as the active beam at the end of the first computation. Since the reverse computation is of conditional probabilities, the probabilities are initialized to 1.0.

In one embodiment, to be discussed in association block 435 of FIG. 4 and block 505 of FIG. 5, the backward computation is continued beyond the time frame at which the forward computation was initialized. From that point on, the backward computation determines its own beam, as illustrated in FIG. 20.

In some embodiments, an unanchored search is a match computation with a specialized network, such as those illustrated in FIG. 9 and FIG. 10. In this case, the initial active set state is the null grammar state in FIG. 9 or the null grammar state 1 in FIG. 10. Since there is only one active state, its probability is initialized to 1.0.

After the probabilities have been initialized for the initial active set, the process proceeds to block 310.

Block 310 reads a frame of acoustic data, to prepare for the computation of the probabilities associated with this next point in time, which is one time unit later if the process is going forward in time and is one time step earlier if the process is going backward in time.

Block 315 propagates the state probabilities. That is, given the distribution of probabilities among the states of the Markov process determined at the previously analyzed time frame, it determines the distribution of the probability for the new current time, taking account of the Markov transition probabilities, but not yet taking account of the new frame of acoustic data.

In most embodiments, for each state there are only a small number of other states to which the Markov transition probability is non-zero. In a finite state network representation, for most nodes there are only a few arcs leaving that node. The only states that can have non-zero probability in the current frame are states that have arcs coming to them from one or more of the states that are active in the previous frame. The sum-of-paths computation is shown in equation (3.1).

αₛᵤₘ(j,t)=Σᵢαₛᵤₘ(i,t−1)A[i,j], (3.1)

where t represents the time frame in the feature sequence, and i and j represent states in the network.

The best path computation finds the best predecessor for each state (if there is a tie, any one of them may be chosen). It also saves a record of which predecessor was chosen, as in equations (3.2).

α_{best}(j,t)=Maxᵢ(α_{best}(i,t−1)A[i,j]), (3.2)

(3.2b) B(j,t) is any value of i for which the Max is achieved

A[i,j] is the Markov transition probability, that is, the conditional probability of the Markov process transitioning to state j at the next time, if it is in state i at the current time. In equation (3.2), if the probabilities are represented by their logarithms, then the multiplication on the right-hand side is replaced by an addition. Because the logarithm function is monotone, the maximum operation remains a maximum operation. Logarithms may also be used in equation (3.1), but then the summation is replaced by a more complicated computation, or an approximation is used.

A[i,j]=Prob(X(t+1)=j|X(t)=i) (3.3)

Because of the Markov property (the definition of a Markov process), A[i,j] is independent of t, so A[i,j] also represents the probability of a transition from time t−1 to time t.

The sum or the Max needs to be taken only over pairs (i,j) for which A[I,j] is non-zero, and only for states i that are in the active beam at time t−1. In the network representation, the pairs (i,j) for which A[I,j] is non-negative are those for which there is an arc going from node i to node j.

Block 315 only propagates the probabilities based at least in part on the Markov transition probabilities. It does not update the probabilities based on the acoustic data observed at time t. That will be done in block 325.

In some embodiments, block 320 injects some extra probability from outside the target network. In some embodiments, an unanchored search is implemented simply as a match between a Markov process and the acoustic data stream, where the Markov process represents not only the target portion of the script network, but also other speech, such as in FIGS. 9 and 10. However, this requires a model for the other speech such that actual instances of the target match better than other speech while the other speech matches better than false alarms. While straight-forward in theory, this requirement can be tricky to achieve in practice (especially for the network in FIG. 9). Therefore, in some embodiments additional mechanisms are used, such as the score adjustment that will be discussed in association with block 330, or an external computation. In some embodiments, these alternatives are so effective that they are used even for the network in FIG. 10. Therefore, in some embodiments of an unanchored search, block 320 injects probability into the entry node of the network, such as the null grammar node in FIG. 9 or the null grammar node 1 in FIG. 10.

Block 325 then matches each active state against the acoustic data for the current frame. Note that more states may have become active because the state probabilities from the previous frame have been propagated along arcs connecting them to additional nodes. There are many different models that may be used to represent the conditional probability distribution for the acoustic features associated with each state of the hidden Markov process, for example Gaussian or Normal distributions, mixtures of Gaussian distributions, and discrete distributions across a finite set of symbols such as phonetic symbols. Embodiments of the invention work with any of these acoustic feature probability distributions, so the particular form of the conditional probability distribution of the acoustic features will not be described further.

For any of the acoustic feature probability distributions, the state probability estimates are updated as shown in (3.4):

α(j,t)<=α(j,t)Prob(Y(t)=y(t)|X(0=j)(update in place) (3.4)

Where Y(t) is a random variable representing the possible acoustic data observations at time t, and y(t) is the actual observed value. The expression in (3.4) is not an equation. Rather, the symbol <= represents an assignment. That is, the previous value of α(j,t) is replaced with the value computed on the right hand side of the expression. If the probabilities are represented by their logarithms, then the multiplication in the computation on the right-hand side is replaced by an addition. Assignment (3.4) can be used for either αₛᵤₘ(j,t) or α_{best}(j,t). In some embodiments, the multiplication by Prob(Y(t)=y(t)|X(t)=j) is included directly in the computations of equations (3.1) and (3.2), rather than being a separate step.

In some embodiments, the conditional probability of the acoustic data observations depends not only on the state at time t, that is X(t), but on which transition was made from time t−1 to time t. In such embodiments, the probability for each transition is included in equations (3.1) and (3.2), and is handled in block 315 rather than in this separate block 325.

In some embodiments, block 330 makes a special adjustment to the scores if the purpose of the match is a detection. This adjustment may be made whether the detection is an unanchored search or is an anchored match done for the purpose of detection or verification. It does not need to be done if the purpose of the match is merely to compute the time alignment of the nodes within the network being matched.

For purposes of block 330, a detection or verification is any match computation in which the match of the specified Markov process is being considered not in absolute terms, but relative to some other possible match. In some embodiments the other possible match might be an approximation or simpler substitute for the other speech represented in FIGS. 9 and 10. In other embodiments, the other possible match might be a more specific alternative rather than all “other speech”, such as a representation specifically of speech sounds that are likely to be confused with the sounds represented in the target network, perhaps restricted to syllables or sound sequences that occur in the particular language.

Unanchored search or verification of an anchored match has advantages and disadvantages relative to large vocabulary continuous speech recognition. On the one hand, only a small number of words or phrases need to be matched, rather than tens or hundreds of thousands. On the other hand, in large vocabulary continuous speech recognition, each hypothesized word is compared against specific alternatives, rather than the vague specification of “other speech.” This vagueness of the alternative is one of the reasons that the false alarm and missed detection rates are much higher for spoken term detection than the insertion and deletion error rates for continuous speech recognition.

In some embodiments, block 330 is designed to make up somewhat for disadvantages of the conventional implementation of the detection task. In one embodiment, block 330 replaces each conditional probability in assignment (3.4) with a likelihood ratio. The likelihood ratio takes the ratio of the likelihood of the acoustic event being modeled (for example, a phoneme) with the likelihood of the best matching alternatives. In one embodiment, the likelihoods are represented by their logarithms and the score is the log-likelihood-ratio. That embodiment has the favorable property that correct hypotheses tend to have positive scores and false hypotheses tend to have negative scores, so there is a natural dividing point between the two conditions, a score of zero. With this score adjustment, the typical match computation will have some phonemes with negative scores, but the accumulated score added across all the phonemes will tend to be positive. In that embodiment, there is a natural score to inject into the starting node in block 320, namely zero.

If the best path computation is being used, then block 335 saves a record of the best predecessor of each active node, that is, the value of β(j,t) in equation (3.2b). This information is saved (and highlighted as a separate block) because this information will be needed for the backward computation, which will trace back through this recorded best-predecessor information. In a sum of paths computation, αₛᵤₘ(j,t) may be saved. In some embodiments, both β(j,t) and α_{best}(j,t) may be saved.

Block 340 updates the determination of the set of active states. Using the state probabilities assigned in expression (3.4), it finds the best scoring state. It then prunes (makes inactive) those states whose probabilities are worse than the probability of the best state by more than a specified amount. The value of the threshold for this pruning is adjusted as a design parameter that trades off reduced computation for some chance that a correct node will be pruned. In most embodiments, the pruning threshold is adjusted to a level such that the rate of occurrences of pruning errors is low. However, it is generally not practical to adjust the pruning threshold to avoid all pruning errors. There are rare, unexpected events whose estimated probability is so low that to avoid pruning them would also require accepting many other low probability events, which would require too much computation. Embodiments of the invention are specifically designed to detect and correct alignment errors that are caused by pruning errors.

Block 350 checks to see if the best scoring state is the end state of the target network. If so, the (direct or forward) match computation is complete. Control goes to block 360, which in some embodiments performs a reverse computation and is some embodiments just returns control to the block that has called the match computation as a subroutine. Block 350 also checks whether the end of a specified time interval has been reached. In some embodiments, such as the target network shown in FIG. 9, the end of the time interval will be the only exit condition.

If the end state is not the best state and the end of the time interval has not been reached, then control continues back around the loop to block 310.

Block 360 optionally performs a reverse computation. In the sum of paths form of the computation, the reverse computation is almost identical to the non-reverse computation, except for a few differences in details. The non-reverse computation is usually initialized as joint probabilities and the reverse computation is usually initialized as conditional probabilities. In some embodiments, the active set for the reverse computation is kept the same as the active set that was used previously in the non-reverse computation. In some embodiments, in particular when the reverse computation is being used for error detection or error correction, the reverse computation computes its own best state and pruning threshold. In some embodiments, the active set for the reverse computation is the union of the active set used for the previous non-reverse computation and the active set independently computed from the reverse computation.

The “end state” for the reverse computation would be the normal starting state for the target network. In some embodiments, in particular when the reverse computation is being used to correct errors in earlier anchor points, the reverse computation is continued back past the time of the anchor point. In some embodiments the network is also augmented with a concatenated network continuing back in the script beyond the script node represented by the anchor point. In one embodiment, this process is continued until the backward computation agrees with the time placement of an anchor point, as illustrated in FIG. 20. The time placement of all anchor points encountered in the reverse computation are updated by a time placement estimated from the combined forward and backward computations.

In some embodiments, by convention β(j,t) represents the probability of all future observations from time t+1 onward, conditional on the Markov process being in state j at time t. The reverse computation used a probability that is conditional on the state at time t because combining a β(j,t) that uses a joint probability with an α(j,t) would double count the fact of being in state j at time t. Similarly, β(j,t) considers acoustic data frames only from time t+1 onwards to avoid counting the observations at time t twice. Thus, in these embodiments, the equation for βₛᵤₘ is as follows:

βₛᵤₘ(j,t)=Σₖβₛᵤₘ(k,t+1)Prob(Y(t+1)=y(t++1)|X(t+1)=k)A[j,k], (3.5)

where the computations corresponding to equation (3.1) and (3.4) have been combined.

In some embodiments, in particular when only an alignment is being computed, the reverse computation for a best path computation is just a traceback. A separate traceback path is computed for each active ending state, if there is more than one. Each traceback simply goes back through the path, picking up the information about the best predecessor for each path node at each time frame:

```
Set ending time t=T; Set ending state best(T) to the designated ending
state.
Loop until stopping condition is met {
      best(t−1) <= B(best(t),t);
      t <= t − 1;
},
where B(s,t) is the best predecessor state saved in equation (3.2).
```

(3.6) Pseudo Code of Traceback Procedure

The stopping condition may be that the traceback procedure has reached the beginning of the traceback data saving during the forward computation. A similar traceback computation is used going forward in time if the first computation was backward in time.

However, in some embodiments, in particular when the reverse computation is being used for error detection or error correction, the reverse computation is a full independent best-path computation similar to the non-reverse computation in the same way that the reverse sum of probabilities computation is similar to its non-reverse computation. The equation for Nest in this embodiment is as follows:

β_{best}(j,t)=Maxₖ{β_{best}(k,t+1)Prob(Y(t+1)=y(t+1)|X(t+1)=k)A[j,k]} (3.7)

In the case of either equation (3.5) or (3.7) an error is detected if the best state in the reverse computation is not among the states that were active during the non-reverse computation. This error detection will be discussed in more detail in association with FIG. 4.

The combination of αₛᵤₘ(j,t) and βₛᵤₘ(j,t) has interesting and useful properties:

γₛᵤₘ(j,t)=αₛᵤₘ(j,t)βₛᵤₘ(j,t) (3.8)

is the joint probability of making all the acoustic data observation in the total time interval and of being in state j at time t.

MatchScore=Σⱼγₛᵤₘ(j,t) (3.9)

is the probability (summed across all paths) of making all the acoustic data observations. MatchScore does not depend on t, because the sum on the right hand side will have the same value for any t.

γ_{best}(j,t)=α_{best}(j,t)β_{best}(j,t) (3.10)

is the probability of the best path that goes through state j at time t.

BestPathScore=Maxⱼγ_{best}(j,t) (3.11)

is the score of the best path, which, despite appearances, does not depend on t.

In some embodiments of a forward-backward computation, in particular for acoustic model training based at least in part on the Baum-Welch algorithm, the backward match computation does not make its own decisions about which states should be active but rather keeps the same active set for each frame that was used for the forward computation. This choice of active set facilitates score normalization. It also keeps the forward and backward beams consistent with each other even if the forward computation makes a pruning error. However, this technique doesn't correct such an error. In fact, it causes it to go undetected. Therefore, in most embodiments of the match computation in embodiments of the invention, the backward computation makes its own decisions of pruning threshold and active set.

In some embodiments, the backward computation may be matching against acoustic data frames that were not previously matched in a forward computation. In that case, the best state and pruning threshold are determined using the scores computed in equation (3.5) or (3.7).

In some embodiments, however, if there has been a previous forward computation to the current frame of the backward computation, then the best state and pruning threshold for the backward computation uses the scores from equation (3.8) or (3.10). It is easily proven that pruning based at least in part on (3.10) does not make any pruning errors, because by definition a pruning error is one that prunes the path that has the best score across the entire time interval. Although a backwards sum of paths computation with pruning based at least in part on the scores from equation (3.8) will prune some of the probability, in a practical sense this backward computation is also “error free”.

Similar “no error” pruning decisions may be made using equation (3.8) or (3.10) when a forward computation is being done for which there has already been a corresponding backward computation. One embodiment of block 575 of FIG. 5 uses this method.

Referring now to FIG. 4, which is an expansion of block 125 of FIG. 1, multiple methods of error detection are used. In any one pass through block 125 of FIG. 1, any number of methods of error detection may be used. In some other embodiments, if computational efficiency is a priority, and if previous checks for errors have not shown any, then most passes through the loop in FIG. 1 may skip error detection. In some embodiments, if there have been previous detections of errors, if there are other reasons to suspect errors, or if minimization of the chance of errors is a priority, then multiple methods of error detection may be used every time through the loop in FIG. 1.

Block 405 performs redundant detections. Redundant detections may be used for multiple independent checks in the same pass through the loop in FIG. 1. That is, for a putative anchor point multiple independent detections may be performed to check their consistency with the location of the anchor point. In particular, unanchored searches may be performed for the same target as the network associated with the anchor point, but over different time intervals. Also, either anchored or unanchored searches may be performed with other target networks.

Block 410 checks for inconsistencies. Generally, locating a different target at the same time as the anchor point would be an inconsistency. Also, locating any target that is at the anchor point or later in the script at a time earlier in the acoustic data stream would be an inconsistency, as would the similar situation with both the orders reversed.

How strongly an inconsistency indicates an error depends on how unique is the target of the particular redundant search. In some embodiments, the target for any redundant search for error detection is chosen to be such that the target appears in the script near the portion of the script associated with the anchor point, but with the target selected such that no other part of the network near the anchor point sounds similar to that particular target. Then any inconsistent detection with a good score is a strong indication that the anchor point might be in error or that the speaker has deviated from the script. In an unanchored search based at least in part on the network in FIG. 10, if the time interval searched includes the correct instance of the target, then that should be the instance detected. If the detected instance is inconsistent, but has a mediocre score, a further search may be conducted using a longer time interval on the consistent side of the anchor. Similarly, if the detected instance is consistent but with a mediocre score then a search with an expanded interval on the inconsistent side may be performed. In any case in which there is some evidence of inconsistency but it is not conclusive, searches for additional targets may be performed to gather additional evidence.

Block 415 performs a different kind of check for indications of problems, which may be performed whether or not block 405 performed redundant detections and whether or not block 410 detected any inconsistencies. Block 415 checks for missed detections and for situations in which a detected target does not match as well as it should. The method that block 415 uses is to perform a match against the same target, but using acoustic models whose probability distributions are more spread out in the space of acoustic features. The more spread out distributions may, for example, be Gaussian distributions with large variances, or they may be mixture distributions with greater spacing among the means of the mixture components. If the models are correct and well-trained, then the normal models should match the acoustic data stream better than the more spread out models. However, if the models are not well-trained, or if what the what the speaker said is similar to the script but not quite the same, then the more spread out models are likely to be a better match to what was spoken than the normal models for what is in the script.

Block 420 checks whether the normal, tighter models score better. Whenever they do not, it is evidence of some potential problem. However, there are other possible causes besides errors in the alignment or deviations of the speaker from the script. For example, the acoustic models might be poorly trained. They may have incorrect means or estimated variances that are less than the true variances. Or the models may assume Gaussian distributions when the true distributions have longer tails. In some embodiments, therefore, when evidence of a problem is detected by block 420, it is not immediately assumed to be an alignment error. Instead, additional matches are performed to verify or reject the putative anchor. These extra matches are not shown separately in FIG. 4, but should be considered part of the test in block 420. In some embodiments, these extra matches are like those described in reference to block 445 and as illustrated in FIG. 24.

Block 425, which can be run independently of blocks 405 and 415, checks to see if a word sequence different from those allowed by the target network matches better than the target. These additional word sequences are represented by modifying the target network by adding extra arcs to allow the additional word sequences.

Block 430 checks whether the target grammar scores better. If the alignment and the script are correct, then no other word sequence should match the acoustic data stream better than target network and its language model score should be worse because the grammar probabilities are spread out. Like the test in block 420, this test by itself is not definitive. However, it is an indication that the speaker may have deviated from the script. The more the score for the alternate word sequence is better than the score for the target network, the stronger is the indication that there is a deviation from the script.

Independent of the other error detection methods, block 435 tries to detect potential errors by computing backward from an independent anchor, as illustrated in FIGS. 19 and 20. It calls the frame-by-frame match routine shown in FIG. 3 as a subroutine. The frame-by-frame details and the issues of initializing the active set and the state probabilities have been discussed in association with FIG. 3.

Block 435 can determine an independent anchor is any of several ways and call an appropriate embodiment of FIG. 3. The anchor for the backward computation needs to be independent in the sense that it makes its own determination of the active beam, so that block 440 can check whether the beams are consistent.

If a forward match computation has been performed starting at the anchor point, as is done for example in the section-by-section embodiment mentioned in the discussion of FIG. 1, then a backward reverse computation can serve as starting backward from an independent anchor if, as explained in association with FIG. 3, it is initialized with a broader beam and uses conditional probabilities. The reverse computation from any unanchored search that detects an instance of its target later than the anchor point being checked can also serve as a backward computation with an independent anchor.

In either case, the backward computation must be either the sum-of-paths match computation (see equation 3.5) or the full backward version of the best path computation (equation 3.7) and the beam pruning must be independent of the beam pruning done in the forward computation.

Block 440 checks whether the beams are consistent, as illustrated in FIGS. 19 and 20. In one embodiment, the beams are considered consistent if the best scoring state in the backward computation was in the active set for the forward computation. This consistency condition would be automatically satisfied if either the traceback computation were used as the reverse of a best path computation, or if the active set for the reverse computation were set equal to the active set from the forward computation. Either way, there would be no chance for block 440 to note an inconsistency and detect an error.

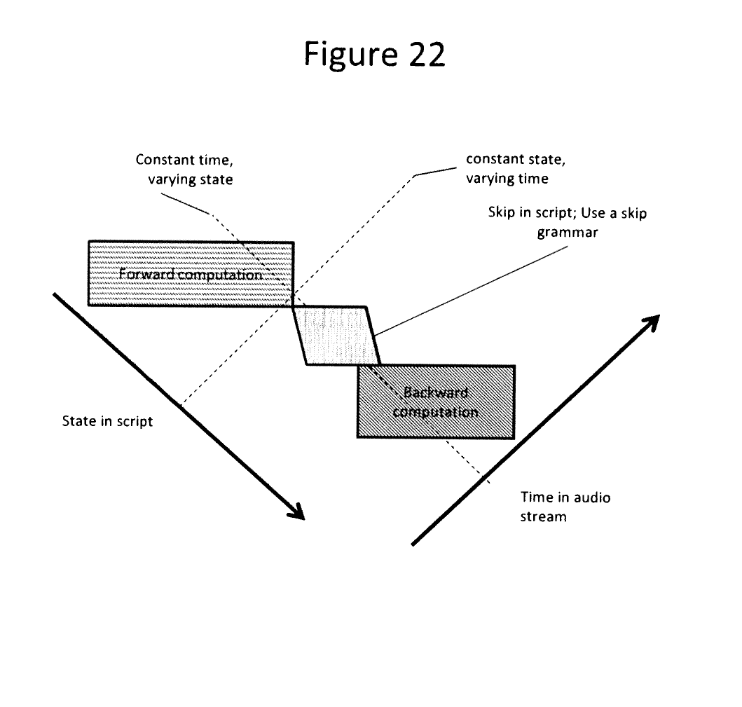

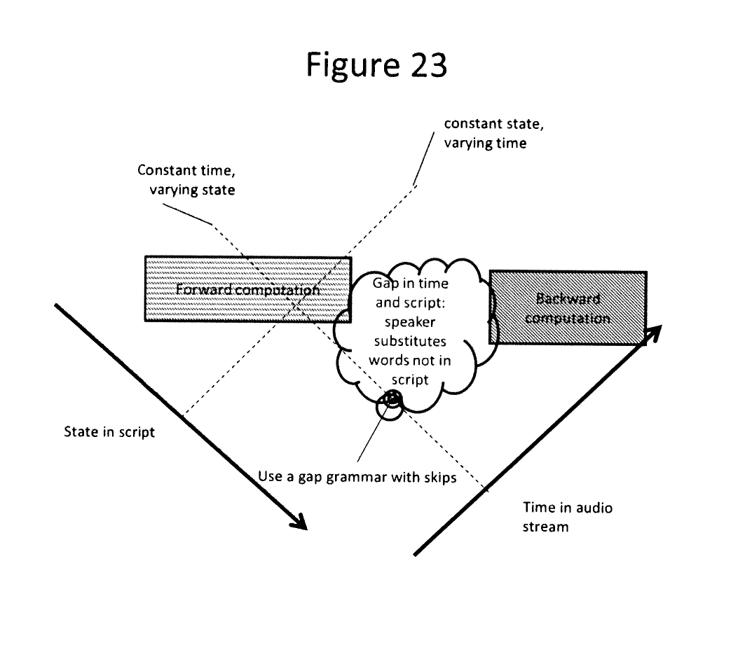

There are several types of errors that the backward computation might detect:
1) A difference between the time distribution computed from the forward computation and the time distribution computed from the combined forward and backward computations, without there having been a pruning error (see FIG. 19);
2) The anchor point is at the right location, but there is a pruning error in the forward computation advancing from the anchor point (see FIG. 20);
3) The backward computation arrives at the script node corresponding to the anchor point at a time that is substantially later than the time of the anchor point (see FIG. 21).
4) The backward computation arrives at the time of the anchor point with it active beam still at a substantially later part of the script than the script node associated with the anchor point (see FIG. 23).
5) The forward and backward matches both get bad scores for some time interval within the time interval between the forward and backward anchor points such that the remedy may require a skip both in time and in the script (see FIG. 22).

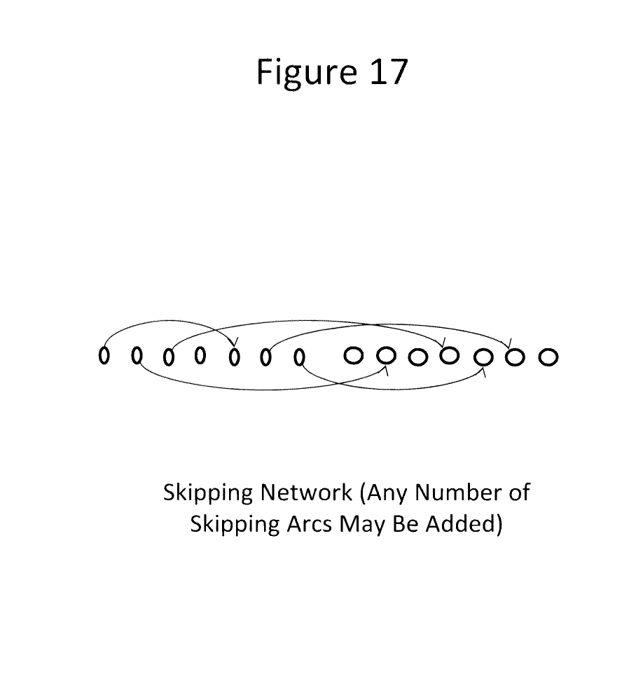

If either condition (3) or (4) occurs, the anchor point might be substantially misplaced, which might have been caused by an error in an earlier anchor point. Some embodiments continue the backward computation until it proceeds backward to an anchor point for which the forward and backward computations agree, as illustrated in FIG. 19. Treat all intervening anchor points as potentially in error. If either condition (3) or condition (5) occurs, some embodiments recompute the matches based at least in part on a grammar that allows a gap in time, such as the grammars in FIGS. 12, 13 and 14. If either condition (4) or condition (5) occurs, some embodiments recompute the matches based at least in part on a grammar that allows skipping in the script, such as the grammar shown in FIG. 17. If condition (5) occurs, some embodiments recompute the matches based at least in part on a grammar that allows both time gaps and skipping in the script.

If the beams are consistent in block 440, or the test in 435 is skipped, the process proceeds to block 445, which matches a portion of script that is adjacent, either before or after, the script node corresponding to the anchor point being tested. In some embodiments the adjacent script in both directions will have already been matched. In that case, the computation in block 445 may be skipped.

In some embodiments, after an unanchored search an anchor point may be located at the beginning of the target network without the preceding script having been matched. In either an unanchored search or a section-by-section anchored match, an anchor point may be located at the end of the target without the following script having yet been matched. In any of these cases, the as yet unmatched adjacent portion of script may be matched as a test to verify or reject the proposed placement of the anchor point, as illustrated in FIG. 24. The match computation on this adjacent script should be treated as an detection rather than an alignment, with the score modification as described in association with FIG. 3.

If all of the test that are performed answer “yes” than no error has been detected. Accept the anchor point as correct unless and until an error is detected in later computation.

If the anchor point fails one or more of the tests, mark it as a potential error for further processing as shown in FIG. 5.

One embodiment of correction mechanisms for each of the error conditions detected by FIG. 4, is shown in the flowchart in FIG. 5. In that embodiment, a match with a gap grammar is performed in block 535 even before the backward match in block 565. In some embodiments, a match with a gap grammar may be performed as a matter of routine. In other embodiments, the match with gap grammar in block 535 may be based at least in part on previous error detection, such as in block 435 of FIG. 4.

Once errors or potential errors have been detected, embodiments of the invention correct wherever possible. If an error cannot be corrected, for example, if the speaker says something that is not in the script, embodiments of the invention attempt to isolate the region of the error and prevent it from influencing the rest of the alignment. There are two primary mechanisms for correcting errors. Combined forward and backward processing is used to eliminate pruning errors and more generally to correct the timing of anchor points.

There are many ways to combine these two principles in order to correct errors. FIG. 5 shows one embodiment. In the discussion of the error detection of block 435 of FIG. 4, different corrective actions are discussed in response to the different ways in which the backward beam may fail to agree with the forward beam. These differences are illustrated FIGS. 20 to 23. In FIG. 5, block 535 performs one or more matches with a gap grammar in block 535, which is before the backward match in block 565. However, in most embodiments, the process shown in FIG. 5 assumes that the error detection processes shown in FIG. 4 have already been done, including the gap-detection of the backward computation in block 435. The selection of gap grammar type in block 535 may be based in part on the relative positions of the forward and backward beams computed in block 435.

Block 505 selects a first anchor point and block 515 selects a second anchor point. These two selected anchor points should bracket the time interval and script portion that contain one or more detected or suspected errors. There may be a limitation on the maximum size of a time interval for the forward and backward matches in blocks 525, 565 and 575, either because of computer limitations or by design choose. Not all of the detected errors need to be covered by a single pair of bracketing anchor points as set by blocks 505 and 515. The process of FIG. 5 may be used more than once, with a different subset of the detected errors handled each time.

If an anchor point has not already been placed at a convenient time for use as the anchor point selected by block 505 or block 515, a new anchor point may be found by doing an unanchored search. In this unanchored search, it is important to find a reliable anchor point, but any script subnetwork may be chosen as the target, so the choice of target can be based at least in part on reliability. In one embodiment any candidate search target is checked to make sure that no other nearby script subnetwork is similar to the candidate search network before the candidate is chosen to find an anchor point.

Once the surrounding anchor points have been selected, block 525 performs a forward match, computing joint probabilities, as shown in FIG. 3. This forward match computation matches the time interval between the two selected anchor points against the script network between the script nodes of the two selected anchor points.

In some embodiments, block 535 computes a forward match using one or more special grammars that represent the possibility that the speaker has said something that is not in the script. In some embodiments, block 535 is only used when there is some suspicion that the speaker has deviated from the script, such as previous tendency to deviate from the script, or a detection of evidence of a deviation from the script such as error type (3), (4) and (5) in block 440. In some embodiments, block 535 does a match against one or more gap grammars in speculation even if block 435 has not been run or has failed to detect a gap.

In particular, block 535 may perform one or more forward matches using one or more of the grammars shown in FIG. 12, 13, 14, or 15. Each of these grammars represents particular ways that the word sequence as spoken may differ from the script. Collectively these grammars are called “gap” grammars because when the speaker says something that is not in the script, it will often leave a “gap” between the active beam computed in the forward match and the active beam computed in the backward match, as detected in block 435 of FIG. 4, and illustrated in FIGS. 21 and 22. With the “gap” grammars, the gap will show up as a section of part of the grammar representing words not in the script having better match scores than the script.

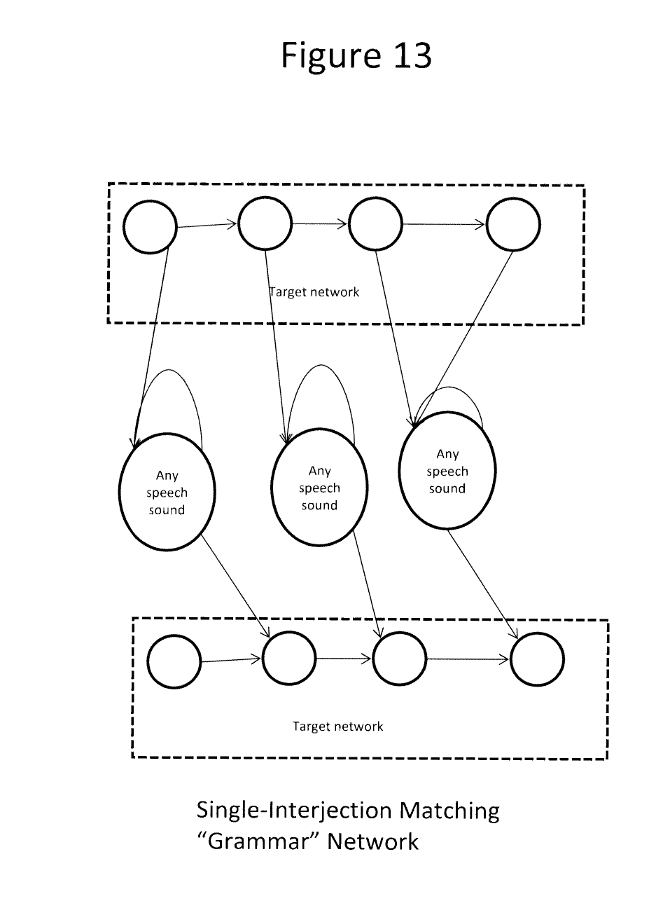

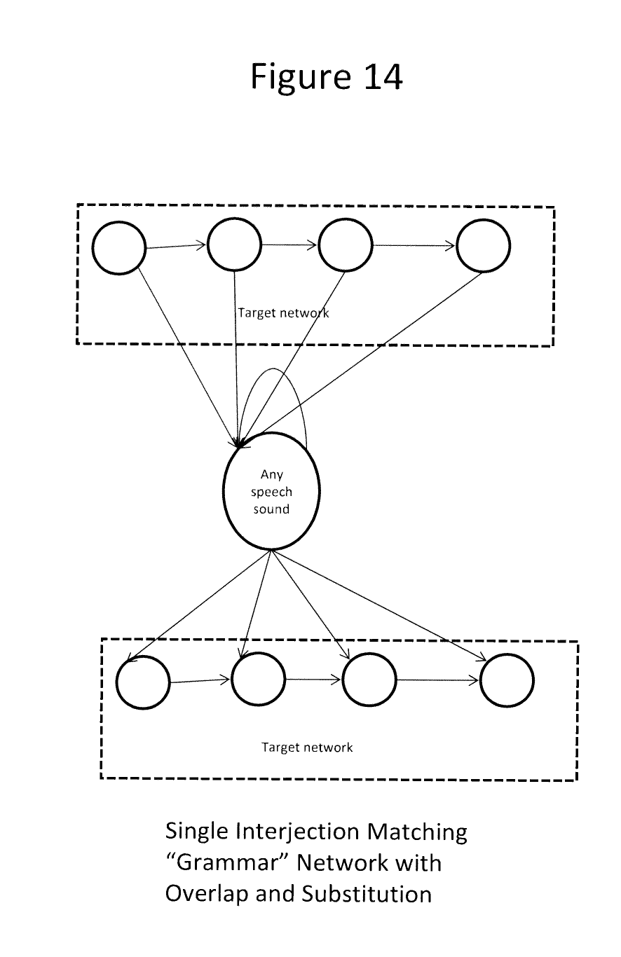

FIGS. 13 and 14 show grammars that represent the constraint that the speaker may deviate from the script for an arbitrarily long interval, but only once within the time interval being searched. If there is more than interval of deviation from the script in the interval being searched, the grammar of FIG. 13 or FIG. 14 will find the one gap that produces the best match. Some embodiments of block 535 search first for the best matching single gap. Then they match the two subintervals before and after that gap to see whether there is an additional gap before or after the first detected gap. This detection and split process may be continued in any subinterval in which a gap is detected until all the gaps have been found.

Block 545 checks whether any of the gap grammars has found a portion of speech not in the grammar that matches better than the script.

If block 545 finds such a script gap, than block 555 constructs a grammar that represents the alternate speech, as well as continuing to represent the script. In some embodiments, the grammar constructed by 555 is not a grammar representing all the possible deviations from the script in the grammars of FIG. 12, 13, 14, or 15, such as might have been used in the forward match detecting the gap. In some embodiments, block 555 makes use of the knowledge gained from the match done it block 535 to know the best matching deviations from the script. Then block 555 represents only those deviations from the script that have significant probability in one of the forward match computations done in FIG. 535. In any the grammar selected in block 555 is then used in the match computations of block 565 and 575, rather than just the network representing the script portion between the two anchor points.

Block 565 computes a backward match with an active beam that is determined independently of the forward active beam. That is, the backward computation is a sum of paths or a full best path computation and the best state and the pruning threshold are determined separately during the backward match computation, not from the active beam of the forward computation. In most embodiments the best state and the pruning threshold for the backward computation is determined by the combined scores given equation (3.8) or (3.10), so there will be no pruning errors. In most embodiments, this backward computation is similar to the one that may have been done in block 435, except that this one may be using a gap grammar selected in block 555.

Also, this backward computation is for error correction, not just for error detection. Therefore, some embodiments of the backward computation for block 565 will keep active all the states that were active in the previous forward computation as well as keeping all the states deeming active by the independent backward beam pruning. This process is done to avoid the backward computation in block 565 from making pruning errors. However, some embodiments of block 435, because it is only used for error detection, will not necessarily keep all those forward states active, so for several reasons the block 435 and block 565 computations may differ. However, if block 435 has already done the same backward computation as is to be done in block 535, the previous results may be used and the computation does not need to be repeated.

Because the original forward computation of block 425 or block 435 may have made pruning errors, block 575 recomputes the forward match. Block 575, however, computes the best scoring state based not on the new forward match score alone. Rather it uses the combined score from equation (3.8) or equation (3.10).

Equation (3.8) or (3.10) is also used to determine the best scoring state for each point in time for the purpose of alignment. Equation (3.10) may also be used to determine the range of times corresponding to each state along the best scoring path. Equation (3.10) may be used to determine a posteriori probability distributions across the times associated with a given state. The range of times or the probability distribution of times associated with the state selected for an anchor point may be used as the times for that anchor point. Using equation (3.8) or (3.10) for pruning scores essentially prevent block 575 from making pruning errors.

Since blocks 565 and 575 use combined scores for pruning, block 575 computes the optimum time placement of each interior anchor point, according to the probabilities specified by the models. If any decision to use a grammar representing deviations from the script made in block 555 is correct, then block 575 will also have determined the optimum times for transitioning between in-script and out-of-script conditions.

Using these alignments, block 585 corrects the timings of all the anchor points between the anchor point selected in block 505 and the anchor point selected in block 515. Additional anchor points may be set based at least in part on any node in the network between the selected anchor points.

FIGS. 6, 7 and 8 are flowcharts for embodiments of the invention in which a rough preliminary alignment is first obtained, followed by detailed alignment with error detection and correction. In one example embodiment for spoken data, the process begins by roughly segmenting the audio data stream using easily detected acoustic events, such as pauses. It then computes an alignment of these segments, treating each segment as a block that is aligned as a unit. It performs error detection and error correction and elimination on this segment-level alignment before proceeding to a detailed frame-by-frame alignment. In other embodiments, the rough alignment may be obtained by other means or the rough alignment may be for sections that are not necessarily sentences.

FIG. 6 is a flowchart for one embodiment of this overall process. In other embodiments, some of the blocks of FIG. 6 may be skipped or may be performed in a different order, depending on the situation and the purpose of the alignment.

Block 605 creates an initial sentence segmentation by looking for easily detected acoustic events, such as pauses in the speech that are too long in duration to be intra-word pauses. In some embodiments, other easily distinguished acoustic events are also detected, such as the sound /s/. Usually, an /s/ is easily distinguished from other sounds, except for /z/. Detecting two or more different sounds provides more information for making the preliminary segmentation of the audio data stream into sentences. For example, the number of times /s/ is detected in a putative sentence segment should be consistent with the number of times /s/ and /z/ occur in the script for the sentence. However, block 605 only performs a preliminary sentence segmentation. It is not assumed that the preliminary segmentation is close to error-free. In fact, in one embodiment the duration threshold for pause detection is deliberately made short so that more extra pauses are detected just so that there will be slightly fewer missed end-of-sentence pauses.

Block 615 performs a full segment-by-segment alignment computation of the audio segments identified in block 605. That is, it associates the beginning and ending time of each segment with particular times in the feature sequence of features. The acoustic events detected bottom-up in block 605 are used as candidate anchor points. However, block 615 performs a kind of unanchored search among the candidate sentence boundaries to find the right one for a given place in the script. The flexibility and robustness of embodiments of the invention allow multiple opportunities for error detection and correction as well as flexibility as to the order in which particular operations are performed. Thus, some error detection may be performed as part of the segment-by-segment alignment, as well as part of an error detection and correction process based at least in part on the results of the segment-by-segment alignment. The details of one embodiment of this error detection is shown in FIG. 7.

Block 625 performs a mixture of error detection, error correction and error elimination, based in part on the analysis shown in FIGS. 7 and 8. As already explained, the processes of block 625 may be intermixed with the segment-by-segment alignment of block 615. In some embodiments, a tentative segment-by-segment alignment is obtained from other sources and error detection and correction such as shown in FIGS. 7 and 8 begins with block 625.

For example, for a video, film or television broadcast there may be closed captioning or subtitles available. Some fraction of the captions, however, may be aligned with wrong portion of the audio-video recording. For example, a caption may be displayed several seconds early or several seconds late, associated with the wrong audio, and may even be associated with a different speaker or a different camera shot. However, in addition to such misalignment, there may be errors in the transcription, especially with transcription of live broadcasts, or the subtitle may be in a different language than the audio. In one embodiment, the segment-by-segment alignment of block 615 may be based at least in part on the closed captions or subtitles with their time stamps, and the error detection and correction begins with block 625.

Another example occurs with audio books that have been recorded in more than one language. The New Testament, for example, has been recorded in over 600 languages. In this case, each chapter and verse of the bible may be associated with a separate audio file so that listeners can hear a particular passage. However, the text in the language of a particular audio recording will not necessarily be available in electronic form, so it may be necessary to recognize and align the audio based at least in part on a translation in a different language than the audio recording. The procedures of block 625 through 665, as explained in FIGS. 7 and 8 and FIGS. 4 and 5 will be necessary.

When the audio and the text are in different languages, with either audio books or subtitles, there will typically be several possible translations for each word or phrase, and the order of the words may be different in the audio than in the text. One embodiment of the invention models these cross-language differences. For each word in the text, a network is constructed that represents each possible translation. Where a phrase has a translation different from that obtained from its component words, that translation is represented as a network as well. Because the word order may be different in the audio, an unanchored search is done for each of these networks, subject to the constraint of detecting one and only one instance of a translation of each text word or phrase using numerically constrained search as illustrated by FIG. 10.

Once the sentences have been aligned and the sentence alignment errors corrected, block 645 performs a detailed alignment of each sentence. In one embodiment, this detailed alignment is just a forward and backward match computation as shown in FIG. 3. However, if the sentence is too long or contains unexpected events causing pruning errors or other alignment errors, one embodiment of block 645 is to do the full process for FIGS. 1 to 5, applied to the one sentence.

Block 655 performs error detection, as discussed in association with FIG. 4. If any error is detected that affects the placement of a sentence boundary, the block 655 continues its error detection into the adjacent sentence.

Block 665 performs error correction and error elimination, as discussed in association with FIG. 5. If correction is made that affects the placement of a sentence boundary, the block 665 continues its corrections into the adjacent sentence.

FIG. 7 is a flowchart for one embodiment of the sentence-by-sentence alignment computation of block 615.

Block 705 marks the pauses or other detected acoustic events that are candidate breaking points in the script. In one embodiment the detected events are all pauses and the breaking points in the script are punctuation such as periods or other indications of end-of-sentence in the script. However, in other embodiments, other breaking points may be used.

Block 710 selects the first anchor, which in most embodiments will be the beginning of the audio data stream and the beginning of the script.

The rest of FIG. 7 can represent either of two embodiments. To lessen confusion, these two embodiments will be discussed separately.

In one embodiment, the loop in FIG. 7 progresses through the audio data stream one sentence at a time, primarily using the detected pauses as anchor points.

Block 720 selects a candidate sentence boundary. In the embodiment being discussed, this candidate sentence boundary will typically be the next detected pause that occurs later in the audio data stream after the last verified anchor point. In some embodiments, other selections are made for the purpose of error detection or error correction.

Block 730 verifies the hypothesis, that is, it tests whether the candidate sentence boundary in the acoustic data stream corresponds to the next sentence boundary in the script. In some embodiments, this verification is done by matching the audio data stream before and after the candidate sentence boundary, as illustrated in FIG. 24. The audio preceding the candidate sentence boundary is matched backwards from the sentence boundary against the script going backwards from the hypothesized location in the script. The audio following the candidate anchor point is matched forward against the script following the hypothesized point in the script. In some embodiments, the score modification of block 330 is made and each test is continued until a statistically significant amount of evidence is accumulated for verification or rejection.

In some embodiments, block 730 performs additional unanchored searches and matches forward and backward from other detected acoustic events, for the purpose of error detection and error correction.

If the candidate sentence boundary is not verified as the next sentence boundary, then processing goes to block 740 to find the best alternative time for the sentence boundary. In some embodiments, block 740 is used even when the hypothesis placement of the sentence boundary is verified. This additional use of block 740 is for the purpose of error detection. The details of one embodiment of block 740 are discussed in association with FIG. 8.

Once the hypothesis is verified, or block 740 completes a search for the best time for the sentence boundary, block 725 checks to see if the processing has reached the end of the audio data stream. If so, the process is complete, except for any additional error detection and error correction that is desired.

In some embodiments, Block 735 performs error detection and error correction, in addition to the error detection and error correction that are performed by blocks 730 and 740. Any sentence boundary selected in block 720 or block 740 and any other target that is located by block 740 may be the basis for a backwards match that verifies or corrects any earlier anchor point, or that may detect a deviation from the script as in block 435 of FIG. 4 and block 565 of FIG. 5.

If the end of the audio file has not been reached, then block 715 selects a verified anchor point. In some embodiments this anchor point is the sentence boundary that has just been located either by block 720 or by block 740. In some embodiments it is a node in the script for the sentence beginning after that sentence boundary that has been aligned in the process of matching forward to verify the sentence boundary. In other embodiments, it may be the last word in the sentence, located by an unanchored search forward from the sentence boundary or an unanchored search backward from the next pause.

The loop returns to block 720, and the process continues to find successive sentence boundaries.

The second embodiment represented by FIG. 7 does a similar process, but progresses primarily from one sentence to the next as determined by the script. It relies on unanchored searches and is less dependent on the bottom-up detection of inter-sentence acoustic pauses.

In this embodiment, block 720 performs an anchored search for a target comprising the last words in the script before the sentence boundary and the first words in the script following the sentence boundary. The target network allows a pause at the end of the sentence, and uses it as an extra indication of a match, but it does not insist on the presence of a detected pause.

One embodiment of block 720 also searches the nearby script for other places that sound similar to sentence-boundary-surrounding target. If it finds any, whether or not they occur at sentence boundaries in the script, it performs unanchored searches for them as well, and passes them to blocks 730 and 740 as additional candidates.

Block 730 verifies the sentence boundary hypothesis as before, except that in this embodiment it matches for the words before and after the target, as illustrated in FIG. 24.

If the hypothesis is not verified or additional error detection is desired, block 740 finds the best scoring alternative, as described in association with FIG. 8.

In this embodiment, block 725 checks whether the processing has reached the end of the script. If so, the processing is done, except that if it is not at the end of the audio data stream, it records that as an error.

In some embodiments, block 735 performs additional error detection and correction, as in the first described embodiment of FIG. 7.

Block 715 selects the verified sentence boundary, after any extra desired error detection and error correction as the next verified anchor point. Block 720 then selects the next sentence boundary in the script as the next candidate sentence boundary.

FIG. 8 is the flowchart of one embodiment of the search for the best alternative sentence boundary in block 740. The process of this flowchart will be done whenever a candidate sentence boundary is rejected by block 730 or additional error detection and correction is desired.

Block 805 selects one or more additional pauses as candidate sentence boundaries. In most embodiments of FIG. 7, the sentence candidate selected by block 720 will be at the first detected pause after the last verified anchor point and the corresponding hypothesized point in the script will be at the next sentence boundary in the script after that verified anchor point. In that case, one embodiment of blocks 805 and 810 is to make each of the next several detected pauses an alternate candidate for the location of the sentence boundary matching the hypothesized point in the script. These candidates test the possibility that the first detected pause was merely an inter-word or intra-word pause, and not a sentence boundary. In some embodiments several additional pauses are hypothesized at once. In one embodiment, one or more additional pauses are hypothesized if the match verification score in block 820 is poor.

Block 820 verifies the match of each of the additional candidate locations for the sentence boundary with matches forward and backward in the audio and in the script, as is block 730 of FIG. 7, as illustrated in FIG. 24.

If a verified match is found, FIG. 8 terminates and returns control to block 740 of FIG. 7.

If none of the candidate pauses produces a verified match, then block 815 performs an unanchored search for a target network that spans the script before and after the sentence boundary being sought. The target network usually will allow for a pause at the end of sentence, which may match a short pause in the audio data stream that was not detected by the preliminary sentence boundary pause detection.

In one embodiment, block 815 first tests the possibility that there was a sentence boundary that didn't produce a pause that was detected in the initial pause detection of block 605 of FIG. 6 and block 705 of FIG. 7. To test this possibility, in one embodiment an unanchored search is performed of the time interval between the last verified anchor point and the candidate sentence boundary that was selected by block 720 of FIG. 7. Some embodiments search a longer time interval for the best match for the target. Other embodiments independently search each of the time intervals between each of the next few detected pauses, to provide multiple candidates for redundancy for error detection.

Block 825 matches forward and backward from the detected target of each of the searches performed in block 815, as done in block 730 in the second described embodiment of FIG. 7, and as illustrated in FIG. 24.

Block 830 verifies whether any detected targets match the adjacent script and audio in addition to their detection match. If one of the targets is verified, the best matching one is selected and control returns to block 740 for FIG. 7.

If none of the targets match, then an error has been detected and it is likely a major error, for example a speaker deviation from the script that makes a significant change in one or more sentences.

Block 840 makes a decision whether to skip a portion of the audio data stream or to attempt to align it in spite of a possible deviation from the script.

If error correction without skipping is to be attempted, then block 835 selects an interval for a section-by-section alignment computation as described in association with FIGS. 1 to 5.

Block 845 goes to block 105 of FIG. 1 to begin the section-by-section alignment process.

If block 840 decides to skip over the current portion of the audio file, it selects another sentence from the skip, chosen to attempt to move to a part of the script beyond the portion during which the speaker has made a major deviation.

Block 860 performs an unanchored search for a target from the selected sentence. The detected target, if verified, is used as a verified anchor point for block 715 in FIG. 7 and the alignment process resumes from that anchor point. In some embodiments, an alignment is also computed backwards in order to fill in the alignment as far as possible back toward the place where the speaker deviates from the script.

Note that the procedure described in association with FIGS. 6 to 8 expects there to be many errors in the preliminary bottom-up sentence segmentation. This embodiment is not based on trying to make a preliminary bottom-up segmentation more accurate. It is quite acceptable for the bottom-up detection to have many missed detections and many false detections. Even without the extra procedures illustrated in FIGS. 6 to 8, the simple section-by-section embodiment of FIGS. 1 to 5 could compute a robust alignment using the bottom-up detection breaks merely as arbitrary section boundaries, without any requirement that they be related to sentence boundaries.

The fact that bottom-up detection of some events, such as long pauses, may be at least be helpful for locating some of the sentence boundaries is mainly used for saving computation. There is no assumption that any of these preliminary sentence boundary indicators are correct.

It is also clear that the procedures shown in the flowcharts of FIGS. 7 and 8 jump back and forth both in the audio data stream and in the script. They also interleave error detection and error correction with each other and with the sentence-by-sentence alignment. Thus, the separation of block 615 of FIG. 6 from block 625 is more a functional separation than a separation of sequential procedures.

The remaining figures are not flowcharts, but rather are diagrams of networks that are used for building target networks for unanchored searches and anchored matches, and illustrations of the relationships between forward and backward matches for error detection and correction.

FIG. 9 is a network enables a continuous speech recognition system to do unanchored searches in a way that is comparable to conventional spoken term detection. This simple grammar alternates between two higher level states. Notice that the grammar can use “any speech sound” to match anything, including instances of the target network. In this grammar, the probabilities from the null state to the two other states, and the probability on the return loop from the “any speech sound” state back to itself, are adjusted to prevent the grammar from always choosing “any speech sound” and further to optimize the trade-off between missed detection of the target versus false alarms.

The grammar network shown in FIG. 9 can be used for unanchored search, but it has a major drawback with respect to the goal of robust alignment. There is no control over whether an anchored search using the network of FIG. 9 will find one instance of the target, none at all, or many instances.

Some embodiments of this invention therefore use the grammar network shown in FIG. 10. This grammar represents the belief that, in the interval being searched, there is one and only one instance of the target network. That is, the grammar network allows any sequence of zero or more speech sounds, followed by exactly one instance of the target network, followed by another sequence of zero or more speech sounds.

This grammar network doesn't require any tricky adjustment of probabilities or other control parameters. It only requires a specification of the time interval to be searched. It always finds the one best matching location for an instance of the target. Unlike most spoken term detection tasks, in most embodiments of this invention the unanchored searches are done over a relatively short portion of the feature sequence or audio data stream, and that portion of the feature sequence is associated with a portion of the script in the target network appears. Thus the assumption that one and only one instance of the target will occur in the search interval is well justified. However, even if the wrong time interval is chosen on one unanchored search, embodiments of the invention do many redundant searches to provide ample means for detection and correction of errors.

FIG. 11 is a simple example of the flexibility enabled by matching the feature sequence against a model for a hidden Markov process rather than just matching it against a word sequence. For example, in continuous speech, most words are spoken one right after another, with no pause. However, speakers always pause occasionally, and it can be very difficult to predict from the script alone exactly when the speaker will pause. FIG. 11 shows how a simple Markov process can represent this uncertainty by allowing an optional pause after each word. The “target word network” in the inner box represents a word sequence as it would be matched if it were assumed that the speaker spoke the phrase continuously without any pauses. The network in the larger box represents the fact that the speaker might pause after any one word, might pause after more than one word, or might not pause at all. Each of these possibilities is represented by a different path through the network.

FIG. 12 shows a grammar network representing that the speaker may deviate from the script. Here the target network is a network for a hidden Markov process, not just a simple word sequence. The diagram is simplified for visual clarity, but the grammar network being represented is understood to have a branch up to a unique “any speech sound” state for every arc in the target network and a branch back down to the state at the end of the arc. This grammar network models the speaker making an arbitrary interjection between any two words in the target network, but still saying everything in the script. That is, this grammar models, for example, off-the cuff parenthetical remarks. This is a possible gap grammar for use in block 535 of FIG. 5.

FIG. 13 shows a more constrained gap grammar. In this network only one interval of deviation from the script is allowed. In the illustrated embodiment, one or more words from the target network are spoken followed by any sequence of speech sounds, followed by one or more words to complete the target network. Optional pauses, although not shown in the figure, can also be allowed in the target network. In fact, it is to be understood that the target network can be an arbitrary hidden Markov process, although only a simple word sequence is shown. Other versions of this gap grammar network may be used to represent different constraints, such as allowing the interjection to occur before any words from the target network. However, in one embodiment of FIG. 5, the gap grammar match of block 535 is performed in a situation in which the anchor points at the ends of the time interval have already been matched against one or more words into the interval, so the form illustrated here is appropriate.

On the other hand, the search interval may contain more than one interval during which the speaker deviates from the script. However, as explained in the discussion of block 535 of FIG. 5, the grammar of FIG. 13 may be used to find one gap at a time until all of them have been found.

Either the grammar of FIG. 12 or the grammar of FIG. 13 may be used for error correction in the situation illustrated in FIG. 21.

Some embodiments of the gap grammar of either FIG. 12 or FIG. 13 can have additional arcs representing that the speaker may also skip part of the script. Some embodiments would use such a gap and skip grammar to represent the situation illustrated in FIG. 23.

FIG. 14 is similar to FIG. 13, but its grammar also allows the speaker to back up and repeat part of the target. FIG. 14 is just an example to illustrate the flexibility that is possible in representing gap grammars.

FIG. 15 represents a gap grammar that is appropriate in a particular situation. If the speaker is reading from a script, then the most common reading errors are for the speaker to skip a word or repeat a word. The grammar network in FIG. 15 is a word sequence network with extra arcs to allow any word to be repeated or to be skipped. Similar extra arcs may be added to any target network.

FIG. 16 is a simplified representation of a word pronunciation. In any grammar network, each word may be replaced by a pronunciation network to produce a large network in which the nodes (or in some embodiments, the arcs) each represent a phoneme, or even a sub-phoneme phonetic unit. In this example word pronunciation network, the word has two pronunciations. One has five phonemes, the other six. The two pronunciations share the first two phonemes and the last phoneme. It is clear that an arbitrary number of pronunciations, with shared pieces, can be represented by such networks.

FIG. 17 is a sketch of a grammar that allows skipping forward multiple words in a script. Some embodiments place a limit on how many words may be skipped in a row, but allow skipping in any position in script network. Such a network is used to represent that the speaker may have deviated from the script by leaving some words out. For example, some embodiments allow such a network in blocks 535, 565 and 575 of FIG. 5. In some embodiments, such a skipping network may also be combined with the methods of gap representation illustrated in FIG. 11, 12 or 13, to represent that the speaker may both skip some words of the script and insert different words.

FIG. 18 shows the relationship between a forward match and a backward match with independent beam pruning being used to detect and correct errors. As explained in reference to FIG. 3, the standard implementation of Baum-Welch training does a forward and backward sum-of-probabilities computation in which the active set for each frame in the backward computation is made the same as the active set for that frame previously used in the forward computation. In standard Viterbi training, or in some embodiments of recognition, the backward computation for a best-path forward computation is simply a traceback along the best path, as in the pseudo-code traceback procedure (3.6). However, these methods force the backward computation to agree with the forward computation, which is useful if there are no pruning errors in the forward computation. However, expecting the unexpected, some embodiments of this invention perform an independent backward computation that sets its own beam pruning criterion and determines its own active set each frame.

Note that FIGS. 18 through 24 are all drawn with tilted axes. This is done so that the beam sketches will be horizontal. A beam will normally progress forward in the script network as it advances in time. Moving from left to right in FIG. 18 represents just such a drift. As the beam moves forward in time and advances in the script, it mostly moves horizontally. The rectangles are just sketches of actual beams, which drift somewhat rather than move strictly horizontally, and which vary in width from frame to frame.

FIG. 19 is a sketch of a backward beam meeting a forward beam in which there is no pruning error, or at most a pruning error of less than the beam width. Even when there is no pruning error, the forward computation uses only the partial information represented by equation (3.4). With the combined forward and backward computations, the more accurate and theoretically correct computation of equation (3.8) or (3.10) may be used.

FIG. 20 is a sketch of the situation in which the backward computation has detected that there is an error. Either the forward computation or the backward computation could be in error, but the fact that the beams do not match up means that at least one them is in error. Therefore, error correction and elimination techniques need to be applied. In some embodiments, the backward computation, while computing its own active set, also keeps active the active set from the forward computation. Therefore, the backward computation is less likely to make a pruning error. In any case, in some embodiments the error correction procedure recomputes the matches using techniques that avoid or model the errors, such as matching using gap or skip grammars, as represented in FIGS. 11 to 17, in situations illustrated in FIGS. 21 to 23.

One error correction mechanism in some embodiments is simply to continue the backward computation until it successfully meets up with a forward beam associated with some earlier anchor point. In some embodiments, that forward beam can then be extended forward and at any intermediate anchor points equation (3.8) or (3.10) can be used to correct the alignment. This mechanism is sufficient to correct normal pruning errors unless there is a major disruption, such as the speaker deviating from the script.

FIG. 21 sketches the situation in which the backward computation gets to the same point in the script as the forward beam, but it gets to that state at a later time than is present in the forward beam. This condition is an indication that either the forward computation contains a severe alignment error or that the speaker deviated from the script and said some extra words not in the script. In some embodiments, the error is corrected merely by extending that backwards computation back to an earlier anchor point, as described in association with FIG. 20. In some embodiments, the matches are recomputed using a gap grammar, such as those in FIGS. 11, 12, 13, 14, 15 and 17.

FIG. 22 sketches the situation in which the backward computation reaches the same time as the beam in the forward computation, but its best state is at a later point in the script than is active in the forward computation. This condition indicates that either there was a pruning error in the forward computation, or the speaker has skipped some of the words in the script. In some embodiments, the pruning error is corrected by continuing the backward computation until it agrees either with an earlier part of this forward beam or with the forward computation associated with an earlier anchor point. In some embodiments, the forward and backward matches are both recomputed using a skipping grammar, such as the ones illustrated in FIGS. 15 and 17.

FIG. 23 sketches the situation in which both the forward and the backward computation come to a portion of the feature sequence in which they both get bad match scores that are bad enough to indicate that there is probably an error. In this case, the error is detected even before detecting the beam miss condition illustrated in FIG. 20. Furthermore, in some embodiments, the fact that the backward computation as well as the forward computation may be misaligned is a strong indication that there is a deviation from the script. Some embodiments recompute the forward and backward matches using a grammar that both allows skipping in the script and allows the speaker to insert extra words that are not in the skip.

FIG. 24 is a sketch of one embodiment of the match verification process used in block 445 of FIG. 4, block 720 of FIG. 7, and blocks 820 and 830 of FIG. 8. The verification process verifies a detected target by matching adjacent sections of the script network against adjacent portions of the feature sequence. In some embodiments, these adjacent matches are performed both forward and backward from the detected target. In some embodiments, the match computation uses a score modification as described in association with block 330 of FIG. 3.

In summary, FIGS. 1 to 5 present a robust procedure for aligning a hidden Markov process model, which may have been derived from a script, to a feature sequence or an audio data stream of arbitrary length. This procedure applies multiple methods for detecting and correcting errors in the alignment. FIGS. 6 to 8 show a related embodiment that substantially reduces the amount of computation by first doing a preliminary bottom-up segmentation of the feature sequence based at least in part on cues such as, in the case of speech data, pauses detected in the audio. Because the preliminary segmentation is very approximate, the procedure adds powerful verification procedures to the robust error detection and error correction procedures of FIGS. 1 to 5.

A variety of different methods, systems and program products result from the foregoing. For example, in embodiments, a method, system and program product for acoustic feature analysis may comprise:

In embodiments, an operation may be performed by one or more computers of obtaining a stream of acoustic features. For example, the acoustic features may be obtained, in embodiments, by signal processing on a stream of audio or a prerecorded audio file.

In embodiments, an operation may be performed by the one or more computers of obtaining a sound script network representing knowledge about which sequences of sounds are expected to occur within the audio file.

For example, in embodiments the sound script network may be obtained from a script or transcript by substituting a pronunciation network for each word in the script.

In embodiments, an operation may be performed by the one or more computers of obtaining an acoustic feature model for the distribution of acoustic features associated with each sound in the sound script network. For example, the acoustic feature network for each sound may be obtained by training a model for the sound based at least in part on instances of the sound in other recordings, in embodiments, possibly spoken by other speakers and possibly even in other languages.

In embodiments, operations may be performed by the one or more computers of repeatedly performing the following detection and testing steps until a stopping criterion is met:
i) Selecting a search target associated with a location in the sound script network;
ii) Selecting a search time interval within the stream of acoustic features to search for said search target wherein the duration of said time interval may be a single point in time;
iii) Searching the selected search time interval for instances of the selected search target;
iv) Obtaining a time location estimate for each detected instance of the selected target within the selected search interval;
v) Adding the obtained time location estimate of each detected instance of the selected target to a collection of time locations;
vi) Detecting errors among said collection of time location estimates based in part on the relationships of their respective associated locations in the sound script network.

In further embodiments, an operation may be performed by the one or more computers comprising eliminating or correcting one or more of the detected errors.

In further embodiments, the acoustic feature analysis may be used by the one or more computers to align the acoustic feature stream to the sound script network.

In further embodiments, the acoustic feature analysis may be used by the one or more computers to recognize speech associated with the acoustic feature stream.

In further embodiments, an operation may be performed by the one or more computers to detect deviations of the acoustic feature stream from the sound script network.

In further embodiments, an operation may be performed by the one or more computers of independently forward and backward matching to detect search errors as well as pruning errors.

In further embodiments, an error detection operation may be performed by the one or more computers of using selected aspects of error correction methods.

In further embodiments, an error detection operation may be performed which locates the single best matching location of an instance of a search target.

In further embodiments, the one or more computers may perform both a forward and a backward best path computation, performing a full best match computation during the second, reverse, computation rather than tracing back through the best path found in the first computation. In further embodiments, the one or more computers may use a comparison of the forward and backward computations for error detection or error correction.

In further embodiments, the one or more computers may perform both a forward and backward match computation performing independent pruning decisions of the active beam in the reverse computation. In further embodiments, the reverse active beam may keep active the states that were active in the first computation as well as though kept active from its independent estimation of the best scoring states. In further embodiments, the one or more computers may use a comparison of the forward and backward computations for error detection or error correction.

In further embodiments, the one or more computers may perform a gap matching computation that matches the audio data within a specified time interval to a sequence consisting of three elements: first one or more words that match an initial portion of the script, second one or more words that do not match the script, and third one or more words that match a final portion of the script, wherein the matching computation finds the best matching location within the specified time interval as the location of the one or more words that do not match the script.

In further embodiments, the one or more computers may repeatedly select time intervals for the gap matching computation by the following process: first the one or more computers may select a time interval that may contain one or more instances of a sequence of one or more words that do not match the script interspersed with sequences of one or more words that do match the script, second the one or more computers may find the best matching location for a single instance of a sequence of one or more words that do not match the script, third the one or more computers may select as time intervals for a further gap matching computation each of the two subintervals created by dividing the original time interval respectively ending one script word before the located sequence that does not match the script and one script word after the located sequence that does not match the script. In further embodiments, the gap matching is performed recursively on each subinterval until each subinterval best matches the script for the subinterval with no intervening sequence of words that do not match the script.

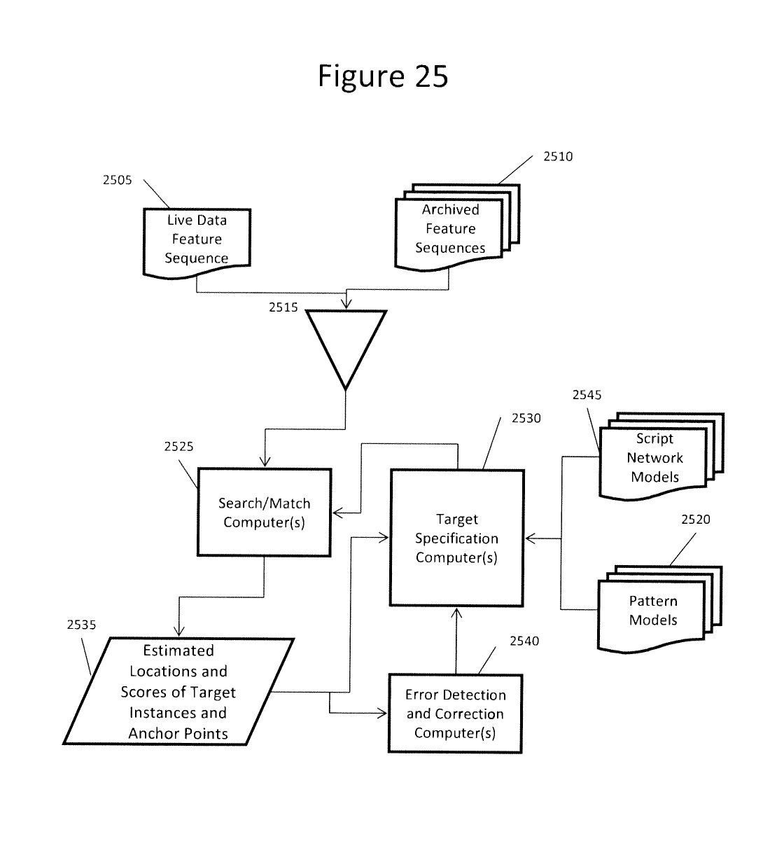

FIG. 25 is a schematic block diagram of a computer implementation that may be used to implement embodiments of the invention. Referring to the figure, one or more sequences of features (or feature vectors) are available from one or more sources as indicated by blocks 2505 and 2510. Block 2505 obtains data in or near real time, such as from recognition during actual operational use.

Block 2510 stores and retrieves previously recorded data, either recorded separately or during earlier recognition transactions.

One or more sequences of feature vectors are obtained from block 2505 and/or block 2510 and merger by block 2515. Conceptually the one or more sequences of feature vectors may be merged into a single long sequence or may be managed as a set of separate sequences.

The sequence(s) of features or feature vectors is sent to a group of one or more computers that perform searching and matching computations in block 2525.

One or more, possibly external, computers in block 2530 specify the target patterns that are to be searched for or matched. The one or more computers in block 2530 also specify the subrange of the sequence of features to be searched for each target. For a match computation, the computers in block 2530 specify an anchor point in the sequence of features and whether the match is to be performed forwards or backwards in the sequence.

The results of the match computations performed by the one or more computers in block 2525 are stored in data storage 2535. In some embodiments, block 2535 may retain and pass to block 2540 more detailed or other additional information from the search and match computations performed by the one or more computers in block 2525. In particular, in some embodiments some “location” specifications may comprise information about an associated node in a script network in addition to information about an estimated location in the sequence of features or feature vectors.

One or more computers in block 2540 detect and possibly correct, errors based at least in part on the estimated locations of detected instances of targets and their match scores. In some embodiments, the one or more computers in block 2540 may request the one or more computers in block 2530 to specify additional searches or matches. For example, the one or more computers in block 2540 may ask for additional searches or matches to verify or reject a tentative error detection, or to correct a detected error.

As stated above, the one or more computers in block 2530 select the targets for the searches and matches performed by the one or more computers in block 2525. These computers select the targets based at least in part on the locations that have been found in previous searches and stored in block 2535. They are also based at least in part on the possible errors detected by the one or more computers in block 2540 or on direct requests from block 2540 for specific additional searches. The one or more computers in block 2530 select the targets for searches from among the pattern models stored in block 2520. This selection is based at least in part on results of previous matches and searches and on the association of detected target instances with nodes in the script network model(s) stored in block 2545. In particular, the one or more computers in block 2530 may select targets in order, progressing systematically through the script network, or may select targets to fill in gaps. Target selection may either be based at least in part on a gap in the sequence of features that has not yet been aligned with the script network or, alternately, may be based at least in part on a gap in the script network that has not yet been aligned with the sequence of features.

The one or more computers in block 2525 and the one or more computers in block 2530 may be external to the one or more computers in block 2540, with communication over external communication channels. For example, either the one or more computers in block 2540 or the one or more computers in block 2530 may be on a server system while the one or more computers in each of the other two blocks may be customer computers that are geographically distributed. Alternately, in some embodiments the one or more computers in two or all three of the blocks may be at a single location. Indeed, in some embodiments, the operations of all three blocks may be on a single computer.

As an illustrative embodiment, consider how the system illustrated in FIG. 25 could align a recorded audio book to its text using an embodiment such as the two stage alignment process illustrated in FIGS. 6 to 8. In one embodiment, the sequence of features may be a sequence of vectors of amplitudes of a Fourier frequency transformation evaluated at a frame rate of one frame per 10 milliseconds. The script networks in block 2545 may be based at least in part on the text of the book, with one or more specified pronunciations for each word, and allowing for optional pauses between words. In one embodiment, the script networks may also model common reading errors or common mispronunciations by the reader.

In one embodiment, the process may begin by the one or more computers of block 2530 selecting as targets one or more patterns from block 2520 that model long pauses in the audio. In one embodiment, the duration of the pauses in the target models may be selected to correspond to the pause duration that typically occurs between sentences. In this embodiment, the one or more computers in block 2530 would specify the entire audio file as the subrange of the sequence of features to be searched in this search for potential sentence pauses.

In this embodiment, the one or more computers in block 2525 will search for instances of the long pause models anywhere in the entire audio file. Of course, some sentences may be followed by only a short pause, or by no pause at all. Also, some long pauses may occur internally within a sentence. Therefore, there will not in general be a one-to-one correspondence between the detected long pauses in the sequence of audio feature vectors and the sentence boundaries in the script.

In one embodiment, the one or more computers in block 2530 will next proceed systematically through the script, determining the correspondence between detected long pauses and script sentence boundaries. The process would begin by aligning the beginning of the script with the beginning of the audio file and, in some embodiments, aligning the end of the audio file with the end of the script. At each stage of this process, until it is complete, there will be one or more candidate correspondences between a detected long pause and a sentence boundary in the script.

For each particular one of these candidate correspondences in this embodiment, the one or more computers in block 2530 would specify as a match target one or more words immediately preceding the particular sentence boundary in the script, or would specify one and/or one or more words immediately following the particular sentence boundary. The match of the preceding words would be performed backwards in time from the particular corresponding long pause in the sequence of audio feature vectors. The match of the following words would proceed forwards in time from the particular long pause in the sequence of audio feature vectors.

In this stage of this embodiment, an error would correspond to a sentence boundary in the script being associated with a pause associated with a different sentence boundary or with a pause within a sentence. Generally, the preceding and following words in the script around the particular sentence boundary would not sound similar to the words around the corresponding location in the audio for a correspondence that is in error.

The one or more computers in block 2540 would detect most of the errors simply based at least in part on the match scores. The match scores for correct correspondences would be in the normal range for correctly aligned matches, while the match scores for most wrong correspondences will be much worse. Furthermore, if by chance the words surrounding an incorrect correspondence happen to sound similar to the actual words for the correct alignment, that condition would be detected by the fact that two or more correspondences for the particular sentence boundary both have scores in the normal range for correct alignments. Both hypotheses could be kept active, for example in a priority queue, so it would not be necessary to just choose the best matching score.

The one or more computers in block 2530 would progress through the script, continuing with the next sentence boundary. In the case in which two or more correspondences have acceptable scores continuations would be computed for each of them. In one embodiment, this process of extending a sequence of correspondences to the next sentence boundary could be implemented as a priority queue search or stack decoder, such as is well known to those skilled in the art of speech recognition. In another embodiment, the priority queue may override score-based priority by priority based first on position in the audio file, giving a computation similar to a multi-stack decoder or a beam search.

In one embodiment, for each sentence boundary being extended to the next sentence boundary, the one or more computers in block 2530 may specify, as the pause to be associated with the next sentence boundary, one or more detected long pauses, including the next detected long pause following the long pause in the particular correspondence being extended. In one embodiment, the long pause in the particular correspondence being extended, and perhaps even earlier pauses, may also be specified as match targets. In one embodiment, the one or more computers in block 2530 may also specify a correspondence in which the next long pause after the long pause in the correspondence being extended corresponds to a sentence boundary later in the script network than the next following sentence boundary. In one embodiment, even sentence boundaries earlier in the script network may be specified as match targets associated with the next long pause. In one embodiment, some of these extra correspondences may be specified in the circumstance in which the match scores for the correspondences for the extensions indicate a probable error in the extended correspondences. This embodiment may be implemented as a priority queue, stack decoder or beam-like search.

In this embodiment, the system of FIG. 25 will proceed systematically through the script network, aligning each sentence boundary with one or more detected long pauses, except in the case in which two adjacent long pauses are aligned to non-adjacent sentence boundaries one or more sentence boundaries in between are skipped. In one embodiment, the computers in block 2530 will keep a cumulative score associated with each sequence of alignment correspondence pairs. When the process finally arrives at the sentence boundary at the end of the script network, the sequence of alignment correspondences associated with the best cumulative score may be chosen as the designated sentence-by-sentence alignment.

In this embodiment, the system proceeds to estimate a word-by-word or phoneme-by-phoneme alignment. In one embodiment, for each pair of successive sentence boundaries in the designated sentence-by-sentence alignment, the entire script network between the two sentence boundaries is specified as a match target model, using as beginning and ending anchor times in the audio stream the pair of long pauses corresponding to the pair of sentence boundaries. In the case in which one or more sentence boundaries are skipped in the designated sentence-by-sentence alignment, the match target model will comprise more than one complete sentence.

In one embodiment, the one or more computers of block 2540 may detect as errors in situations in which the scores for the word-by-word match between a pair of sentence boundaries is worse than the normal range of match scores for a correct alignment. In one embodiment, the computers of block 2540 may request additional unanchored searches using part of the segment or the entire segment between the pair of designated sentence boundaries as target models and specifying a subrange of times in the audio with a beginning time earlier than the designated time and an ending time later than the designated ending time. Successfully finding a better matching alignment would verify the error detection and provide a candidate for a corrected alignment, to be verified by consistency with adjacent alignments.

As a second illustrative embodiment consider the alignment of an audio file with a script that is not in the same language. Such a task may occur, for example, in aligning an audio book for a translated book for which only the text in the original language is available. Another example would be the alignment of a movie, television broadcast or video to the text of subtitles in a different language. This illustrative embodiment assumes that the translation corresponds to the original on a sentence-by-sentence basis, or at least close to sentence-by-sentence.

In this second illustrative embodiment, the process would begin by searching for long pauses, in the same way as the first illustrative embodiment described above for a normal audio book.

In one embodiment, again in the next step the system proceeds similarly to in the first illustrative embodiment. The one or more computers of block 2530 proceed systematically through the script, determining the correspondence between detected long pauses and script sentence boundaries. This progression from beginning to end of the script is appropriate for subtitles and for any translation in which the translated sentences are mostly in the same order as in the original test.

In this second illustrative embodiment, the test of whether a particular pause corresponds to a particular sentence boundary, however, is different. When a sentence is translated for one language to a second language, the translated words do not necessarily occur in the same order in the second language as in the original words in the first language. In particular the words at the beginning and end of the sentence in the translation are not necessarily word-for-word translations of the initial and ending words in the original sentence.

In one embodiment, all known translations of any word, or any phrase that translates as a unit, may be selected as a match target. A match is computed for each such target both at the beginning of the audio for the translated sentence and at the end of the translated sentence. In one embodiment such matches are made at several long pauses before and after the particular long pause in the correspondence pair being tested. In this embodiment, these surrounding long pauses are including in the test not only to detect and correct errors in the previous detection of sentence boundaries as long pauses, but also to model the possibility that the translation sentences may be split or merged and some words and phrases may have translations that shift to a different sentence. In this embodiment, each match score is compared not only to the normal range of match scores for correct alignments, but also against the match score for the same target in other positions in the audio. A successful match will usually be the best score for its target among all the positions scored and it will almost always be at least close to the best score. In this embodiment, the best scoring position in the script for the words surrounding a particular long pause will not necessarily be at a sentence boundary in the script. In this embodiment, each long pause would get one or more match scores, but not every sentence boundary would be matched against the audio. In this embodiment, the stack or multi-stack decoder would be based at least in part on the long pauses rather than based at least in part on sentence boundaries. That is, it would computed cumulative match scores from one long boundary to another, perhaps skipping around in the script.

In another embodiment, only translations of the words and phrases at the beginning and end of the designated script sentence are specified as targets. However, in this embodiment an unanchored search is made for each target, rather than just a match anchored at a long pause. The specified subrange for each unanchored search would include the audio for the entire sentence and a few surrounding sentences. In this embodiment, the best scoring position in the audio for a particular sentence boundary will not necessarily be at a long pause. In this embodiment, the stack decoder may be based at least in part on the script sentence boundaries in the script rather than on the long pauses. This computation would therefore be similar to the well-known stack or multi-stack decoders based at least in part on words in continuous speech recognition, in which there is often no pause between words.

In a third embodiment, both the anchored matches and the unanchored searches would be performed. A stack or multi-stack decoder for this embodiment could be based at least in part on either script sentence boundaries or long pauses in the audio.

Once the computers in block 2530 have progressed to the end of the script network, a traceback computation may be performed to find the best scoring sentence-level alignments between the script and the audio. For some tasks, subtitle alignment, for example, sentence-level alignment is adequate, so the single best scoring alignment is chosen and the task is complete.

For some tasks, it is desired to compute a word-level alignment, to the extent that that is possible within the limitations of imperfect or incomplete translation. Obviously a particular word in the audio can be aligned to a word only if the translation system hypothesizes the correct word at least as a possibility.

To get a partial word-level alignment, for a particular sentence-level alignment, every word and unit phrase in the sentence is translated, with all reasonable translations being hypothesized. Each hypothesized translation is made a target for an unanchored search. The subrange for audio to be searched for each target is the entire audio segment aligned to a particular sentence in the sentence-level alignment. A simple stack decoder finds the best scoring selections among the candidate translations.

In embodiments, the system may use unrestricted large vocabulary speech recognition to fill in words matching sections of audio that have not been matched well with any of the candidate translations. The vocabulary of the continuous speech recognition would not be restricted to translations of the script. In one embodiment, the words recognized would be used for semi-supervised training of the translation system.

In one embodiment, the system would attempt to learn pronunciation models for new words. If there is no large vocabulary speech recognition capability for the spoken language, and also for any audio segments that have not been successfully recognized, a new entry is created in a pronunciation dictionary for each unmatched audio segment, even though the spelling or correct translation of the word is not known. After a sufficient amount of data has been processed, similar sounding acoustic models that reoccur in the context of similar translations are grouped together as being likely to be instances of the same word. Thus, the system could automatically learn a new language without samples of the written language.

In implementations, the system may be communicatively coupled to one or more networks via a communication interface. The one or more networks may represent a generic network, which may correspond to a local area network (LAN), a wireless LAN, an Ethernet LAN, a token ring LAN, a wide area network (WAN), the Internet, a proprietary network, an intranet, a telephone network, a wireless network, to name a few, and any combination thereof. Depending on the nature of the network employed for a particular application, the communication interface may be implemented accordingly. The network serves the purpose of delivering information between connected parties.

In implementations, the Internet may comprise the network. The system may also or alternatively be communicatively coupled to a network comprising a closed network (e.g., an intranet). The system may be configured to communicate, via the one or more networks, with respective computer systems of multiple entities.

The system may comprise, in implementations, a computing platform for performing, controlling, and/or initiating computer-implemented operations, for example, via a server and the one or more networks. The computing platform may comprise system computers and other party computers. The system may operate under the control of computer-executable instructions to carry out the process steps described herein. Computer-executable instructions comprise, for example, instructions and data which cause a general or special purpose computer system or processing device to perform a certain function or group of functions. Computer software for the system may comprise, in implementations, a set of software objects and/or program elements comprising computer-executable instructions collectively having the ability to execute a thread or logical chain of process steps in a single processor, or independently in a plurality of processors that may be distributed, while permitting a flow of data inputs/outputs between components and systems.

The system may comprise one or more personal computers, workstations, notebook computers, servers, mobile computing devices, handheld devices, multi-processor systems, networked personal computers, minicomputers, mainframe computers, personal data assistants, Internet appliances (e.g., a computer with minimal memory, disk storage and processing power designed to connect to a network, especially the Internet, etc.), or controllers, to name a few.

Embodiments include program products comprising machine-readable media with machine-executable instructions or data structures stored thereon. Such machine-readable media may be any available storage media which can be accessed by a general purpose or special purpose computer or other machine with a processor. By way of example, such machine-readable storage media can comprise RAM, ROM, EPROM, EEPROM, CD-ROM or other optical disk storage, magnetic disk storage or other magnetic storage devices, or any other storage medium which can be used to store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention have been described in the general context of method steps which may be implemented in embodiments by a program product including machine-executable instructions, such as program code, for example in the form of program modules executed by machines in networked environments. Generally, program modules include routines, programs, objects, components, data structures, etc., that perform particular tasks or implement particular data types. Multi-threaded applications may be used, for example, based at least in part on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced with one or multiple computers in a networked environment using logical connections to one or more remote computers (including mobile devices) having processors. Logical connections may include the previously noted local area network (LAN) and a wide area network (WAN) that are presented here by way of example and not limitation. Embodiments of the invention may also be practiced in distributed computing environments where tasks are performed by local and remote processing devices that are linked (either by hardwired links, wireless links, or by a combination of hardwired and wireless links) through a communications network. In a distributed computing environment, program modules may be located in both local and remote memory storage devices.

All components, modes of communication, and/or processes described heretofore are interchangeable and combinable with similar components, modes of communication, and/or processes disclosed elsewhere in the specification, unless an express indication is made to the contrary. It is intended that any structure or step of an implementation disclosed herein may be combined with other structure and or method implementations to form further implementations with this added element or step.

While this invention has been described in conjunction with the exemplary implementations outlined above, it is evident that many alternatives, modifications and variations will be apparent to those skilled in the art. Accordingly, the exemplary implementations of the invention, as set forth above, are intended to be illustrative, not limiting. Various changes may be made without departing from the spirit and scope of the invention.

What is claimed is:

1. A system of pattern analysis comprising:
one or more computers, configured with program code to perform, when executed, the steps:
obtaining or receiving, by the one or more computers, a sequence of features;
obtaining or receiving, by the one or more computers, a plurality of pattern models; and
performing, by the one or more computers, a plurality of searches for instances of one or more pattern models in a specified subset of said plurality of pattern models to determine one or more estimated locations of instances of the one or more pattern models within said sequence of features by matching the one or more particular models in said plurality of pattern models;
performing, by the one or more computers, one or more tests to detect errors in said estimated locations of instances matching the one or more particular models and obtaining test results;
wherein each of said plurality of searches is performed within a specified subrange of said sequence of features; and
wherein for each of said plurality of searches, the specified subset of pattern models to be matched, and the specified subrange of the sequence of features to be search, is based at least in part on the estimated locations of the instances of previous searches and is based at least in part on the test results of said one or more tests to detect errors in said estimated locations of matches in said previous searches.

2. The system of pattern analysis as defined in 1, wherein said sequence of features is associated with a sequence of points in time.

3. The system of pattern analysis as defined in 1, wherein the one or more computers are further configured with program code to perform, when executed, the steps:
obtaining or receiving, by the one or more computers, a script-like network model for the sequence of features, and
obtaining or receiving, by the one or more computers, one or more of said pattern models based at least in part on a subnetwork of said script-like network.

4. The system of pattern analysis as defined in 3, wherein one or more of said tests to detect errors in said estimated locations further comprises one or more anchored matches of one or more subnetworks of said script-like network that are adjacent in said script-like network to a previously matched subnetwork.

5. The system of pattern analysis as defined in 3, wherein said plurality of searches are configured to produce estimated locations aligning a sequence of pattern models to substantially all of said sequence of features.

6. The system of pattern analysis as in defined 3,
wherein said plurality of searches are configured to produce estimated locations aligning portions of said script-like network to portions of said sequence of features and
further comprises the one or more computers configured with program code to perform, when executed, the step of determining that one or more remaining portions of said sequence of features do not match well with the corresponding portions of said script-like network.

7. The system of pattern analysis as defined in 3, further comprising the one or more computers configured with program code to perform, when executed, the step:
obtaining or receiving a preliminary association of each of a plurality of special locations in the sequence of features with one or more locations in the script-like network model.

8. The system of pattern analysis as defined in 7, wherein one or more of said plurality of special locations in the sequence of features is tentatively identified as a possible inter-sentence pause.

9. The system of pattern analysis as defined in 7, further comprising the one or more computers configured with program code to perform, when executed, the steps:
testing, by the one or more computers, the preliminary association of one or more of the special locations with a particular point in the script-like network; and
performing, by the one or more computers, forward and backward matches of adjacent portions of the script-like network against adjacent portions of the sequence of features.

10. The system of pattern analysis as defined in 3, further comprising the one or more computers configured with program code to perform, when executed, the steps:
obtaining or receiving, by the one or more computers, a set of externally specified estimated locations corresponding to a plurality of points in the script-like network model;
testing, by the one or more computers, one or more of the externally specified estimated locations; and
correcting, by the one or more computers, errors detected in the externally specified estimated locations.

11. The system of pattern analysis as defined in 1, wherein said sequence of features is a sequence of acoustic features associated with a time sequence of speech data.

12. The system of pattern analysis as defined in 11, further comprising the one or more computers configured with program code to perform, when executed, the steps:
obtaining or receiving, by the one or more computers, a language model based at least in part on one of a grammar or a statistical language model for sequences of word-like entities that sequences of such word-like entities are likely to match subsequences of said sequence of features; and
obtaining or receiving, by the one or more computers, one or more of said pattern models based at least in part on sequences of one or more of said word-like entities.

13. The system of pattern analysis as defined in 12, wherein said plurality of searches are configured to produce matches corresponding to recognition of one or more portions of said sequence of features as sequences of said word-like entities.

14. The system of pattern analysis as defined in 12, wherein each of said word-like entities is a sequence of sound units.

15. The system of pattern analysis as defined in 14, wherein one or more of said sequences of sound units is one of a demi-syllable, a syllable, a sequence of syllables, a word or a sequence of words.

16. The system of pattern analysis as defined in 1, wherein one or more of said searches is an unanchored search.

17. The system of pattern analysis as defined in 1, wherein one or more of said searches is an anchored match.

18. The system of pattern analysis as defined in 1, wherein one or more of said searches is an unanchored search and one or more searches is an anchored match.

19. The system of pattern analysis as defined in 1, wherein one or more of the searches are configured to be performed by a match computation proceeding forward in the sequence of features and one or more of the searches configured to be performed by a match computation proceeding backward in the sequence of features.

20. The system of pattern analysis as defined in 19, further comprising the one or more computers configured with program code to perform, when executed, the step of beam pruning of the one or more backward match computations independently of any beam pruning of any of the forward match computations.

21. The system of pattern analysis as defined in 19, further comprising the one or more computers configured with program code to perform, when executed, the step of detecting discrepancies between the forward match computation and the backward match computation,
wherein one or more of the tests to detect errors in the estimated locations is based at least in part on the discrepancies between the forward match computation and the backward match computation.

22. The system of pattern analysis as defined in 1, further comprising the one or more computers configured with program code to perform, when executed, the steps:
performing, by the one or more computers, a plurality of searches in overlapping specified subranges of the sequence of features; and
detecting, by the one or more computers, inconsistencies among the plurality of the searches performed in the overlapping specified subranges,
wherein one or more of the tests to detect errors in the estimated locations is based at least in part on the inconsistencies among the plurality of the searches performed in the overlapping specified subranges.

23. The system of pattern analysis as defined in 1, further comprising the one or more computers configured with program code to perform, when executed, the step of eliminating one or more of the errors detected in said estimated locations of matches.

24. The system of pattern analysis as defined in 1, further comprising the one or more computers configured with program code to perform, when executed, the step of correcting one or more of the errors detected in said estimated locations of matches.

25. The system of pattern analysis as defined in 23, further comprising correcting, by the one or more computers, the error in one or more estimated locations by replacing a location estimate by a new location estimate that is based at least in part on the combined information from a forward alignment computation and a backward alignment computation.

26. A system of pattern analysis comprising:
one or more computers, configured with program code to perform, when executed, the steps:
obtaining or receiving, by the one or more computers, a sequence of features;
obtaining or receiving, by the one or more computers, a primary model for a particular pattern;
obtaining or receiving, by the one or more computers, an estimated beginning time or an estimated ending time for an instance of the particular pattern in the sequence of features;
performing, by the one or more computers, a unidirectional first match computation based at least in part on the primary model for an instance of the particular pattern matched against the sequence of features beginning at the estimated beginning time or ending at the estimated ending time to obtain a set of active states and a match score for each of the active states;
pruning, by the one or more computers, the set of active states in the first match computation as a function of the time in the sequence of features such that not all states in the primary model are active for each time point in the sequence of features;
performing, by the one or more computers, a second, reversed, match computation for an instance of the particular pattern matched against the sequence of features with the match computation proceeding in the opposite time direction from the first match computation to obtain a set of active states and a match score for each of the active states;
pruning, by the one or more computers, the set of active states in the second match computation based at least in part on the match scores from the opposite time direction in a manner such that states that were pruned and made inactive at a particular time point in the first match computation may be active in the second match computation; and
detecting, by the one or more computers, discrepancies between the first match computation and the second match computation based at least in part on disagreements in pruning decisions of the second match computation and the first match computation.

27. The system of pattern analysis as defined in 26, further comprising the one or more computers configured with program code to perform, when executed, the step of performing the pruning of the set of active states in the first match computation based at least in part on the match scores of each of the active states at a given time point in the sequence of features.

28. The system of pattern analysis as defined in 27, further comprising the one or more computers configured with program code to perform, when executed, the step of detecting when one or more of the active states in the second match computation would have been pruned and made inactive in the first match computation.

29. The system of pattern analysis as defined in 26, further comprising the one or more computers configured with program code to perform, when executed, the steps:
performing, by the one or more computers, a revised match computation in the same time direction as the first match computation based at least in part on keeping active and not pruning one or more states that are active in the second match computation but not active in the first match computation;
computing, by the one or more computers, an optimum state sequence for matching the particular pattern against the sequence of features based at least in part on the revised match computation and the second match computation; and
detecting, by the one or more computers, when a state in the optimum state sequence would have been pruned and made inactive in the first match computation at a time that it would be active in the optimum state sequence.

30. A system of pattern analysis comprising:
one or more computers, configured with program code to perform, when executed, the steps:
obtaining or receiving, by the one or more computers, a particular sequence of features;
obtaining or receiving, by the one or more computers, a particular model for a particular pattern;
obtaining or receiving, by the one or more computers, a background model collectively representing all other patterns;
obtaining or receiving, by the one or more computers, a specification of a subsequence of the sequence of features;
obtaining or receiving, by the one or more computers, a specification of the number of times that instances of the particular pattern occur in the specified subsequence; and
performing, by the one or more computers, a numerically constrained unanchored search in the specified subsequence to obtain best estimated locations for a set of the instances of the particular pattern where the number of instances exactly matches the specification of the number of times that the particular pattern occurs in the specified subsequence.

31. The system of pattern analysis as defined in 30, wherein the specified number of times that the particular pattern occurs in the specified subsequence is exactly one.

32. The system of pattern analysis as defined in 30, further comprising the one or more computers configured with program code to perform, when executed, the steps:
obtaining, by the one or more computers, a partial script-like network model for a specified subsequence of the sequence of features;
selecting, by the one or more computers, as the particular pattern particular pattern model based at least in part on a particular subnetwork of said partial script-like network model;
specifying, by the one or more computers, the number of times that the particular pattern occurs in the specified subsequence based at least in part on a number of times that the particular subnetwork, or similar subnetworks, occurs within the partial script-like network model; and
performing, by the one or more computers, the unanchored search for instances of the particular pattern based at least in part on the specification.

33. The system of pattern analysis as defined in 32, wherein the partial script-like network and the specified subsequence of the sequence of features are based at least in part on estimated locations in the sequence of features of a pair of points in a script-like network for a larger portion of or all of the sequence of features.

34. The system of pattern analysis as defined in 33, comprising the one or more computers configured with program code to perform, when executed, the step of performing a plurality of the searches in a range to be searched in the specified subsequence by successively dividing the range into smaller subranges and searching that subrange based at least in part on the estimated locations found for particular patterns in previous searches.

35. The system of pattern analysis as defined in 30,
wherein the particular sequence of features is in one language, and
wherein the one or more computers are further configured with program code to perform, when executed, the step of obtaining at least in part the particular pattern by translating a word or phrase of a second language for use in the numerically constrained unanchored search.
